(19) United States
(12) Patent Application Publication
(10) Pub. No.: US 2026/0264223 A1
(43) Pub. Date: Sep. 10, 2026

(54) APPARATUS FOR TRANSFERRING SUBSTRATE IN VACUUM CHAMBER

(71) Applicant: T-Robotics Co., Ltd., Osan-si (KR)

(72) Inventors: Soo Jong LEE, Suwon-si (KR); Chang Seong LEE, Hwaseong-si (KR); Chang Hyun JEE, Anyang-si (KR); Sang Hwi HAM, Seoul (KR); Sung Pyo LEE, Pyeongtaek-si (KR); Tae Han LEE, Yangju-si (KR)

(21) Appl. No.: 19/555,807

(22) Filed: Mar. 3, 2026

(30) Foreign Application Priority Data
Mar. 5, 2025 (KR) 10-2025-0028198
Jun. 25, 2025 (KR) 10-2025-0083983

(51) Int. Cl. B25J 9/10; B25J 9/12; B25J 15/00; B25J 19/00

(52) U.S. Cl. CPC B25J 9/106; B25J 9/102; B25J 9/126; B25J 15/0014; B25J 19/0025

(57) ABSTRACT

A substrate transfer apparatus that transfers a substrate in a vacuum chamber is provided. The substrate transfer apparatus comprises: an elevating robot including: (i) an elevating shaft through which an a-th hollow hole is formed, and an elevation driving unit for moving vertically and rotating the elevating shaft; (ii) a travel robot including: a b1-st travel link arm and a b2-nd travel link arm; and (iii) a transfer robot including: a transfer arm platform, a first transfer arm part, and a second transfer arm part.

### CROSS REFERENCE TO RELATED APPLICATION

This application claims the benefits of priorities to Korean Provisional Patent Application No. 10-2025-0028198, filed on Mar. 5, 2025, and Korean Non-Provisional Patent Application No. 10-2025-0083983, filed on Jun. 25, 2025, the entire contents of which being incorporated herein by reference.

### FIELD OF THE DISCLOSURE

The present disclosure relates to a substrate transfer apparatus; and more particularly, to the substrate transfer apparatus that allows a long-distance transfer of a substrate within a vacuum chamber.

### BACKGROUND OF THE DISCLOSURE

In general, a substrate such as a wafer for a semiconductor device, a glass substrate for a display device, a glass substrate for a thin film solar cell, or a glass substrate for a high-performance semiconductor may be manufactured by performing various processes on the substrate. During these processes, the substrate is loaded and processed in a substrate processing apparatus that provides optimal conditions required for each of the processes. Additionally, a mask as the substrate may be used to form various patterns.

Nowadays, in order to improve a productivity for the substrate, a cluster-type substrate processing apparatus capable of collectively processing the substrate is being developed and used.

The cluster-type substrate processing apparatus includes a load lock chamber for loading or unloading the substrate, a transfer chamber for transferring the substrate, and a plurality of process chambers for performing each manufacturing process.

Additionally, a substrate transfer robot, installed in the transfer chamber that is in a vacuum state, may transfer the substrate back and forth between the transfer chamber and the load lock chamber, among multiple transfer chambers, or in and out of the process chambers.

Recently, in order to cope with a large size of the substrate and to improve a substrate processing capability, various researches are in progress to establish a structure capable of processing two substrates in one process chamber or to change an octagonal structure in which four process chambers are installed at equal distances around the transfer chamber to a tetragonal structure having the processing chambers installed on both sides of a transfer path of the transfer chamber.

Meanwhile, in order to deal with an offset distance between respective locations of the two substrates in a structure where they are positioned within one process chamber and in order to account for install locations of each of the process chambers in the tetragonal structure, moving a position of the substrate transfer robot is inevitably required.

To this end, recently, after a travel robot is installed inside a vacuum chamber and then a transfer robot is installed on the travel robot, the travel robot is driven to move the transfer robot to a set position inside the vacuum chamber, and the transfer robot is then driven to transfer the substrate.

However, in a conventional substrate transfer apparatus like above, the travel robot is formed with a complex structure to move the transfer robot for transferring the substrate within the vacuum chamber, and since an equipment for the travel must be installed in an inner space, the travel robot has a large volume in a height direction.

Thus, the conventional substrate transfer apparatus has a disadvantage of requiring a lot of cost to manufacture the travel robot.

Also, according to an installation of the travel robot, a height from a bottom of the transfer chamber to a top of the substrate transfer apparatus increases, thereby increasing a volume of the transfer chamber itself where the substrate transfer apparatus is installed. Therefore, the manufacturing cost of the substrate manufacturing equipment increases.

Consequently, the increased volume of the transfer chamber itself increases operating costs for maintaining vacuum in the transfer chamber.

### SUMMARY OF THE DISCLOSURE

It is an object of the present disclosure to solve all the aforementioned problems.

It is another object of the present disclosure to provide a more compact substrate transfer apparatus capable of improving an efficiency related to an installation area and an installation height.

It is still another object of the present disclosure to provide the substrate transfer apparatus capable of minimizing vibration and/or disturbance with a simple structure and minimizing changes in a pose of the substrate transfer apparatus due to thermal expansion.

It is still yet another object of the present disclosure to provide the substrate transfer apparatus capable of fundamentally preventing a particle generation within a vacuum chamber and having a vacuum sealing structure.

It is still yet another object of the present disclosure to provide the substrate transfer apparatus capable of reducing manufacturing and operating costs of a substrate manufacturing equipment.

The characteristic configurations of the present disclosure for achieving the object of the present disclosure as described above and realizing the characteristic effects of the present disclosure which will be described below are as follows.

In accordance with one aspect of the present disclosure, there is provided the substrate transfer apparatus that transfers a substrate in a vacuum chamber, comprising: an elevating robot including: (i) an elevating shaft through which an a-th hollow hole is formed, and (ii) an elevation driving unit for moving vertically and rotating the elevating shaft, wherein the elevating robot is sealably coupled with a vacuum chamber through-hole formed in a lower region of the vacuum chamber; a travel robot including: (i) a b1-st travel link arm, wherein a b1-st driving motor and a b-th speed reducer which is interlocked with the b1-st driving motor to reduce a rotational speed of the b1-st driving motor by half are installed in a sealed inner space of the b1-st travel link arm, wherein a (b1_1)-st driving shaft which is interlocked with the b-th speed reducer and a (b1_1)-st output shaft which is interlocked with the (b1_1)-st driving shaft are sealingly installed on a b1-st one-end area of the b1-st travel link arm, wherein a (b1_1)-st hollow hole is formed through the (b1_1)-st driving shaft, wherein a (b1_2)-nd driving shaft interlocked with the b1-st driving motor and a (b1_2)-nd output shaft interlocked with the (b1_2)-nd driving shaft are sealingly installed on a b1-st opposite-end area of the b1-st travel link arm, wherein a (b1_2)-nd hollow hole is formed through the (b1_2)-nd driving shaft, and wherein the (b1_1)-st output shaft is fixedly coupled with the elevating shaft of the elevating robot, and (ii) a b2-nd travel link arm, wherein a b2-nd driving motor is installed in a sealed inner space of the b2-nd travel link arm, wherein a b2-nd one-end area of the b2-nd travel link arm is fixedly coupled with the (b1_2)-nd output shaft of the b1-st travel link arm, and wherein a b2-nd driving shaft interlocked with the b2-nd driving motor and a b2-nd output shaft interlocked with the b2-nd driving shaft are sealingly installed on a b2-nd opposite-end area of the b2-nd travel link arm, wherein a b2-nd hollow hole is formed through the b2-nd driving shaft; and a transfer robot including: (i) a transfer arm platform, wherein the transfer arm platform has (i-1) a c0-th coupling hole formed at a c-th center area which is a specific area on a center line corresponding to a linear movement direction of the substrate to be transferred, wherein c0-th stopping member, through which a c0-th vertical through-hole corresponding to the b2-nd hollow hole of the b2-nd driving shaft of the b2-nd opposite-end area of the b2-nd travel link arm of the travel robot is formed, compartmentalizes the c0-th coupling hole into a c0-th upper space and a c0-th lower space, wherein the c0-th upper space is sealed by a c0-th cover, (i-2) a c1-st coupling hole formed at a c-th one-end area of a one-side area with respect to the center line, wherein a c1-st stopping member, through which a c1-st vertical through-hole is formed, compartmentalize the c1-st coupling hole into a c1-st upper space and a c1-st lower space which is sealed by a c1-st cover, (i-3) a c2-nd coupling hole formed at a c-th opposite-end area of an opposite-side area with respect to the center line corresponding to the c-th one-end area, wherein a c2-nd stopping member, through which a c2-nd vertical through-hole is formed, compartmentalizes the c2-nd coupling hole into a c2-nd upper space and a c2-nd lower space which is sealed by a c2-nd cover, (i-4) a (1_1)-st blade and a (1_2)-nd blade formed respectively at a forward part and a backward part of the c1-st coupling hole, and (i-5) a (2_1)-st blade and a (2_2)-nd blade formed respectively at the forward part and the backward part of the c2-nd coupling hole, and wherein the b2-nd output shaft of the b2-nd opposite-end area of the b2-nd travel link arm of the travel robot inserted into the c0-th lower space is fixedly coupled with the c0-th stopping member, (ii) a first transfer arm part, wherein the first transfer arm part has a (1_1)-st transfer link arm, a (1_2)-nd transfer link arm, a first common link arm, a (1_1)-st subordinate link arm which is parallel to the (1_1)-st transfer link arm, a (1_2)-nd subordinate link arm which is parallel to the (1_1)-st transfer link arm, a (1_3)-rd subordinate link arm which is parallel to the (1_2)-nd transfer link arm, a (1_4)-th subordinate link arm which is parallel to the first common link arm, and a first end-effector, wherein a c1-st driving motor and a c1-st speed reducer which is interlocked with the c1-st driving motor to reduce a rotational speed of the c1-st driving motor by half are installed in a sealed inner space of the (1_1)-st transfer link arm, wherein a (c1_1)-st driving shaft interlocked with the c1-st speed reducer and a (c1_1)-st output shaft interlocked with the (c1_1)-st driving shaft are sealingly installed on a (c1_1)-st one-end area of the (1_1)-st transfer link arm, wherein a (c1_1)-st hollow hole is formed through the (c1_1)-st driving shaft, wherein a (c1_2)-nd driving shaft interlocked with the c1-st driving motor and a (c1_2)-nd output shaft interlocked with the (c1_2)-nd driving shaft are sealingly installed on a (c1_1)-st opposite-end area of the (1_1)-st transfer link arm, wherein a (c1_2)-nd hollow hole is formed through the(c1_2)-nd driving shaft, wherein the (c1_1)-st output shaft of the (1_1)-st transfer link arm is fixedly coupled with a c1-st linking member that is inserted into the c1-st upper space of the transfer arm platform to be fixedly coupled with the c1-st stopping member, wherein a (c1_2)-nd one-end area of the (1_2)-nd transfer link arm is fixedly coupled with the (c1-2)-nd output shaft of the (1_1)-st transfer link arm through a first fixed coupling shaft, wherein a c1-st center area of the first common link arm is rotatably coupled with the first fixed coupling shaft, wherein a (c1_4)-th one-end area of the (1_1)-st subordinate link arm is rotatably coupled with the (1_1)-st blade of the transfer arm platform and a (c1_4)-th opposite-end area of the (1_1)-st subordinate link arm is rotatably coupled with a (c1_3)-rd one-end area of the first common link arm, wherein a (c1_5)-th one-end area of the (1_2)-nd subordinate link arm is rotatably coupled with the (1_2)-nd blade of the transform arm platform and a (c1_5)-th opposite-end area of the (1_2)-nd subordinate link arm is rotatably coupled with a (c1_3)-rd opposite-end area of the first common link arm, wherein (c1_6)-th one-end area of the (1_3)-rd subordinate link arm is rotatably coupled with a (c1_3)-rd opposite-end area of the first common link arm, wherein a (c1_7)-th one-end area of the (1_4)-th subordinate link arm is rotatably coupled with a (c1_6)-th opposite-end area of the (1_3)-rd subordinate link arm and a (c1_7)-th opposite-end area of the (1_4)-th subordinate link arm is rotatably coupled with the (c1_2)-nd opposite-end area of the (1_2)-nd transfer link arm, and wherein the first end-effector is fixed to the (c1_7)-th opposite-end area of the (1_4)-th subordinate link arm to thereby support the substrate, and (iii) a second transfer arm part, wherein the second transfer arm part has a (2_1)-st transfer link arm, a (2_2)-nd transfer link arm, a second common link arm, a (2_1)-st subordinate link arm which is parallel to the (2_1)-st transfer link arm, a (2_2)-nd subordinate link arm which is parallel to the (2_1)-st transfer link arm, a (2_3)-rd subordinate link arm which is parallel to the (2_2)-nd transfer link arm, a (2_4)-th subordinate link arm which is parallel to the second common link arm, and a second end-effector, wherein a c2-nd driving motor and a c2-nd speed reducer which is interlocked with the c2-nd driving motor to reduce a rotational speed of the c2-nd driving motor by half are installed in a sealed inner space of the (2_1)-st transfer link arm, wherein a (c2_1)-st driving shaft interlocked with the c2-nd speed reducer and a (c2_1)-st output shaft interlocked with the (c2_1)-st driving shaft are sealingly installed on a (c2_1)-st one-end area of the (2_1)-st transfer link arm, wherein a (c2_1)-st hollow hole is formed through the (c2_1)-st driving shaft, wherein a (c2_2)-nd driving shaft interlocked with the c2-nd driving motor and a (c2_2)-nd output shaft interlocked with the (c2_2)-nd driving shaft are sealingly installed on a (c2_1)-st opposite-end area of the (2_1)-st transfer link arm, wherein a (c2_2)-nd hollow hole is formed through the (c2_2)-nd driving shaft, wherein the (c2_1)-st output shaft of the (2_1)-st transfer link arm is fixedly coupled with a c2-nd linking member that is inserted into the c2-nd upper space of the transfer arm platform to be fixedly coupled with the c2-nd stopping member, wherein a (c2_2)-nd one-end area of the (2_2)-nd transfer link arm is fixedly coupled with the (c2-2)-nd output shaft of the (2_1)-st transfer link arm through a second fixed coupling shaft, wherein a c2-nd center area of the second common link arm is rotatably coupled with the second fixed coupling shaft, wherein a (c2_4)-th one-end area of the (2_1)-st subordinate link arm is rotatably coupled with the (2_1)-st blade of the transfer arm platform and a (c2_4)-th opposite-end area of the (2_1)-st subordinate link arm is rotatably coupled with a (c2_3)-rd one-end area of the second common link arm, wherein a (c2_5)-th one-end area of the (2_2)-nd subordinate link arm is rotatably coupled with the (2_2)-nd blade of the transform arm platform and a (c2_5)-th opposite-end area of the (2_2)-nd subordinate link arm is rotatably coupled with a (c2_3)-rd opposite-end area of the second common link arm, wherein (c2_6)-th one-end area of the (2_3)-rd subordinate link arm is rotatably coupled with a (c2_3)-rd opposite-end area of the second common link arm, wherein a (c2_7)-th one-end area of the (2_4)-th subordinate link arm is rotatably coupled with a (c2_6)-th opposite-end area of the (2_3)-rd subordinate link arm and a (c2_7)-th opposite-end area of the (2_4)-th subordinate link arm is rotatably coupled with the (c2_2)-nd opposite-end area of the (2_2)-nd transfer link arm, and wherein the second end-effector is fixed to the (c2_7)-th opposite-end area of the (2_4)-th subordinate link arm to thereby support the substrate.

As one example, the travel robot rotates in conjunction with a rotational movement of the elevating shaft according to an operation of the elevation driving unit of the elevating robot, to thereby determine a travel direction of the travel robot, wherein the transfer robot travels linearly in the travel direction according to an operation of the b1-st driving motor of the travel robot, to thereby determine a transfer position of the transfer robot for transferring the substrate, and wherein the transfer robot rotates according to an operation of the b2-nd driving motor of the travel robot, to thereby determine a transfer direction of the transfer robot for transferring the substrate.

As one example, the b1-st driving motor and the b2-nd driving motor of the travel robot operate sequentially to determine the transfer position and the transfer direction of the transfer robot, or operate simultaneously to determine the transfer position and the transfer direction of the transfer robot.

As one example, the elevation driving unit of the elevating robot and the b2-nd driving motor of the travel robot operate sequentially to determine the travel direction of the travel robot and the transfer direction of the transfer robot, or operate simultaneously to determine the travel direction of the travel robot and the transfer direction of the transfer robot.

As one example, a height of the second fixed coupling shaft is set as higher than a height of the first fixed coupling shaft such that the first end-effector and the second end-effector are positioned at different heights on a same route.

As one example, the transfer arm platform of the transfer robot further includes a c1-st wiring hole connecting the c0-th upper space and the c1-st lower space; and a c2-nd wiring hole connecting the c0-th upper space and the c2-nd lower space.

As one example, the transfer arm platform of the transfer robot includes an upper plate and a lower plate, wherein the upper plate includes the (1_1)-st blade, the (1_2)-nd blade, the (2_1)-st blade and the (2_2)-nd blade, and wherein the lower plate is coupled with the upper plate, wherein a c0-th upper coupling hole, which is a part of the c0-th coupling hole, is formed at the c-th central area of the upper plate, wherein a c1-st upper coupling hole, which is a part of the c1-st coupling hole, is formed at the c-th one-end area of the upper plate, and the c1-st stopping member, through which the c1-st vertical through-hole is formed inside the c1-st upper coupling hole, compartmentalize an inner space of the c1-st upper coupling hole, wherein a c2-nd upper coupling hole, which is a part of the c2-nd coupling hole, is formed at the c–th opposite-end area of the upper plate, and a c2-nd stopping member, through which the c2-nd vertical through-hole is formed inside the c2-nd upper coupling hole, compartmentalize an inner space of the c2-nd upper coupling hole, wherein a c0-th lower coupling hole, which is another part of the c0-th coupling hole, is formed at the c-th central area of the lower plate, and the c0-th stopping member, through which the c0-th vertical through-hole is formed inside the c0-th lower coupling hole, compartmentalize an inner space of the c0-th lower coupling hole, wherein a c1-st lower coupling hole, which is another part of the c1-st coupling hole, is formed at the c-th one-end area of the lower plate, wherein a c2-nd lower coupling hole, which is another part of the c2-nd coupling hole, is formed at the c-th opposite-end area of the lower plate.

As one example, a c1-st upper wiring slot and a c2-nd upper wiring slot are formed at a lower surface of the upper plate, wherein the c1-st upper wiring slot connects an inner space of the c0-th upper coupling hole with a lower space of the c1-st upper coupling hole, and wherein the c2-nd upper wiring slot connects the inner space of the c0-th upper coupling hole with a lower space of the c2-nd upper coupling hole, and wherein a c1-st lower wiring slot and a c2-nd lower wiring slot are formed at an upper surface of the lower plate, wherein the c1-st lower wiring slot connects an upper space of the c0-th lower coupling hole with an inner space of the c1-st lower coupling hole, and wherein the c2-nd lower wiring slot connects the upper space of the c0-th lower coupling hole with an inner space of the c2-nd lower coupling hole.

### BRIEF DESCRIPTION OF THE DRAWINGS

The accompanying drawings used to explain example embodiments of the present disclosure are only part of example embodiments of the present disclosure and other drawings may be obtained based on the drawings by those skilled in the art of the present disclosure without inventive work.

FIGS. 1A and 1B are drawings illustrating a cluster-type substrate processing apparatus in which a substrate transfer apparatus is installed in accordance with one example embodiment of the present disclosure.

FIGS. 2A and 2B are drawings schematically illustrating the substrate transfer apparatus in accordance with one example embodiment of the present disclosure.

FIGS. 3A to 3C are drawings schematically illustrating an elevating robot in the substrate transfer apparatus in accordance with one example embodiment of the present disclosure.

FIGS. 4A to 4C are drawings schematically illustrating a travel robot in the substrate transfer apparatus in accordance with one example embodiment of the present disclosure.

FIGS. 5A and 5B are drawings schematically illustrating a transfer robot in the substrate transfer apparatus in accordance with one example embodiment of the present disclosure.

FIGS. 6A to 6C are drawings schematically illustrating a transfer arm platform of the transfer robot in the substrate transfer apparatus in accordance with one example embodiment of the present disclosure.

FIG. 7 is a drawing schematically illustrating a (1_1)-st transfer link arm of the transfer robot in the substrate transfer apparatus in accordance with one example embodiment of the present disclosure.

FIG. 8 is a drawing schematically illustrating a connecting part between the (1_1)-st transfer link arm and a (1_2)-nd transfer link arm of the transfer robot in the substrate transfer apparatus in accordance with one example embodiment of the present disclosure.

### DETAILED DESCRIPTION OF THE PREFERRED EMBODIMENTS

The following detailed description of the present disclosure refers to the accompanying drawings, which show by way of illustration a specific embodiment in which the present disclosure may be practiced, in order to clarify the objects, technical solutions and advantages of the present disclosure. These embodiments are described in sufficient detail to enable those skilled in the art to practice the present disclosure.

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar functionality throughout the several views.

To allow those skilled in the art to carry out the present disclosure easily, the example embodiments of the present disclosure will be explained by referring to attached diagrams in detail as shown below. For reference, in the term "A_B" used in the following description, "A" is a number used to distinguish each component, and "B" is a number used to indicate detailed components included in each component. In addition, the "substrate" in the present disclosure may be a glass substrate, but is not limited thereto.

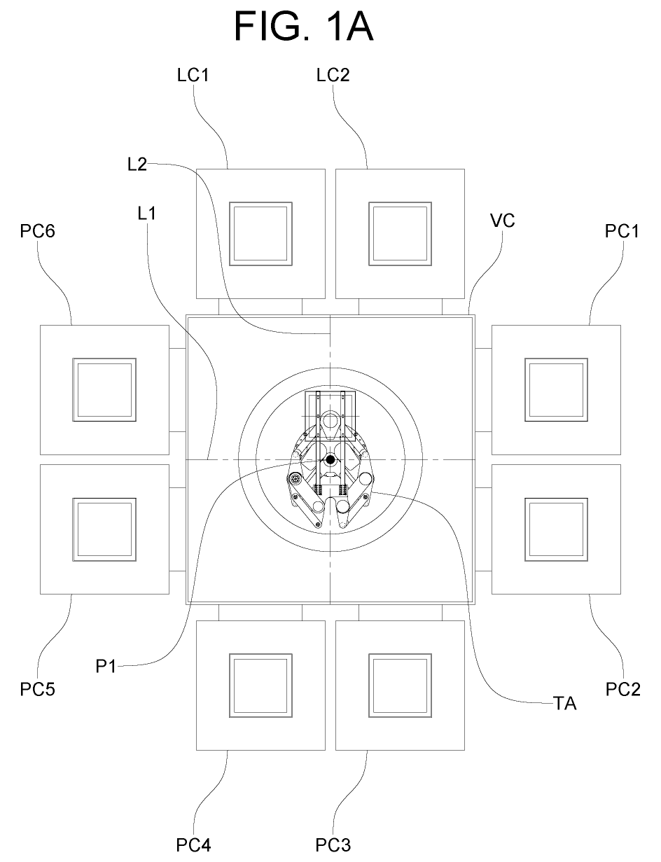

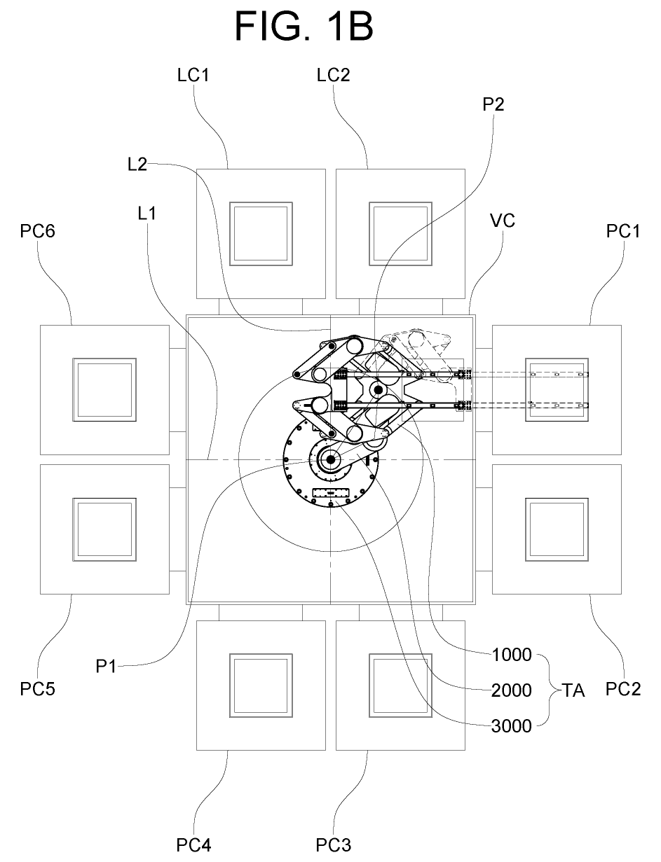

FIGS. 1A to 1B are drawings illustrating a cluster-type substrate processing apparatus in which a substrate transfer apparatus is installed in accordance with one example embodiment of the present disclosure.

FIGS. 1A and 1B are related to a substrate processing apparatus in which two load lock chambers LC1, LC2 are installed on one-side (an upper side in the drawings) of a vacuum chamber VC, which is a transfer chamber having a tetragonal structure, and six process chambers PC1 to PC6 are installed, with two respective process chambers provided on each of remaining three sides of the vacuum chamber VC. Herein, the substrate transfer apparatus TA including an elevating robot 1000, a travel robot 2000 coupled with an upper part of the elevating robot 1000, and a transfer robot 3000 coupled with an upper part of the travel robot 2000 is fixedly installed at a specific position P1 within the vacuum chamber VC. Further, the travel robot 2000 of the substrate transferring apparatus TA moves the transfer robot 3000 to transfer the substrate to each of positions of each process chamber. For reference, FIGS. 1A and 1B illustrate two chambers installed on each side of the vacuum chamber VC, but the present disclosure is not limited thereto, and three or more chambers may be installed on each side of the vacuum chamber VC.

As an example, on a plane viewed from above the vacuum chamber VC, in case a first direction is defined by one direction passing through two opposing sides and a second direction is defined by another direction orthogonal to the first direction, a center axis of the elevating robot 1000, i.e., a center axis of an elevating shaft of the elevating robot 1000, is located at a position P1 where a first direction center line L1 and a second direction center line L2 intersect, wherein the first direction center line L1 is a center line in the first direction, the second direction center line L2 is a center line in the second direction. However, the present disclosure is not limited thereto, and the center axis of the elevating shaft may be located on any position within the vacuum chamber VC, within a range where the rotating transfer robot 3000 does not collide with side walls of the vacuum chamber VC.

A process of transferring the substrate in the vacuum chamber VC by using the substrate transfer apparatus TA is as follows.

As an example, the substrate transfer apparatus TA is initially positioned at the position P1 and transfers the substrate to the process chamber PC1. The elevating robot 1000 of the substrate transfer apparatus TA rotates the travel robot 2000 so that the travel robot 2000 faces a preset position P2 for transferring the substrate to the process chamber PC1, to thereby determine a travel direction of the travel robot 2000. In addition, the travel robot 2000 moves the transfer robot 3000 from the position P1 to the position P2, to thereby determine a transfer position of the transfer robot 3000. Further, the travel robot 2000 rotates the transfer robot 3000 to face the process chamber PC1, to thereby determine a transfer direction. Then, the transfer robot 3000 may transfer the substrate to the process chamber PC1. According to the operating processes above, the substrate transfer apparatus TA may transfer the substrate between the load lock chambers LC1, LC2 and the process chambers PC1 to PC6.

However, the operation of the substrate transfer apparatus TA for transferring the substrate is not limited to the processes described above, and the substrate may be transferred by various methods.

That is, the rotation of the travel robot 2000 according to the elevating robot 1000 to determine the travel direction of the travel robot 2000, the movement of the transfer robot 3000 according to the travel robot 2000 to determine the transfer position of the transfer robot 3000, and the rotation of the transfer robot 3000 according to the travel robot 2000 to determine the transfer direction of the transfer robot 3000 may each be performed individually, or at least two or more operations may be performed simultaneously.

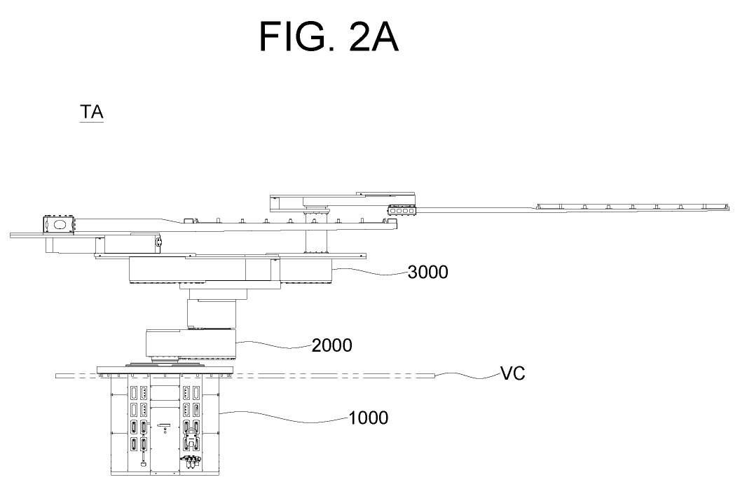

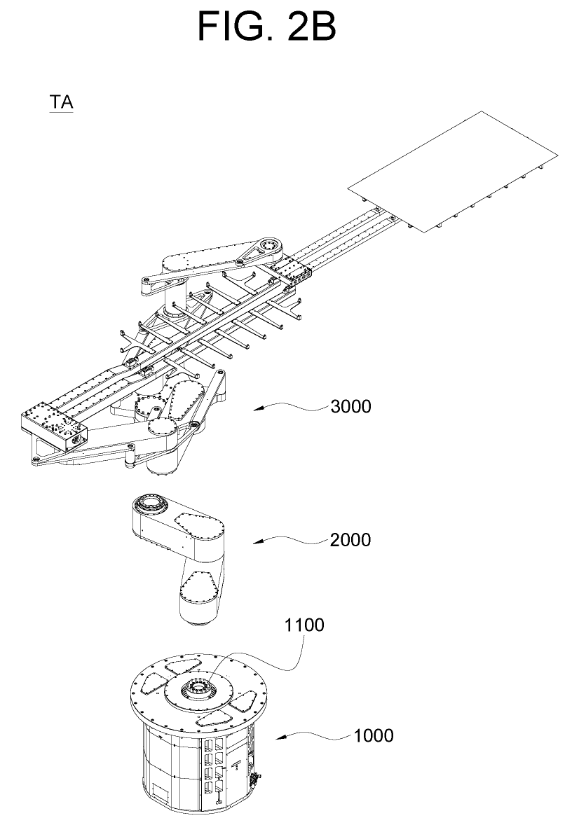

FIGS. 2A and 2B are drawings schematically illustrating the substrate transfer apparatus TA in accordance with one example embodiment of the present disclosure.

By referring to FIGS. 2A and 2B, the substrate transfer apparatus TA may include the elevating robot 1000, the travel robot 2000 coupled with the elevating robot 1000, and the transfer robot 3000 coupled with the travel robot 2000. The meaning of “coupled with” may represent “engaged with”.

First, the elevating robot 1000 may be located in an outer lower region of a housing that seals an inner space of the vacuum chamber VC, and an upper region of the elevating robot 1000 may be sealingly coupled with a vacuum chamber through-hole (not shown) which is formed in a lower region of the housing of the vacuum chamber VC. Further, the elevating robot 1000 may vertically move and rotate an elevating shaft 1100 through which an a-th hollow hole is formed.

Through this, by regulating a vertical position of the transfer robot 3000 through a vertical movement of the elevating shaft 1100, the elevating robot 1000 can make the transfer robot 3000 be located at a height which is appropriate for loading or unloading the substrate into or from the process chamber. In addition, by rotating the travel robot 2000 through the rotation, the elevating robot 1000 can determine the travel direction of the travel robot 2000.

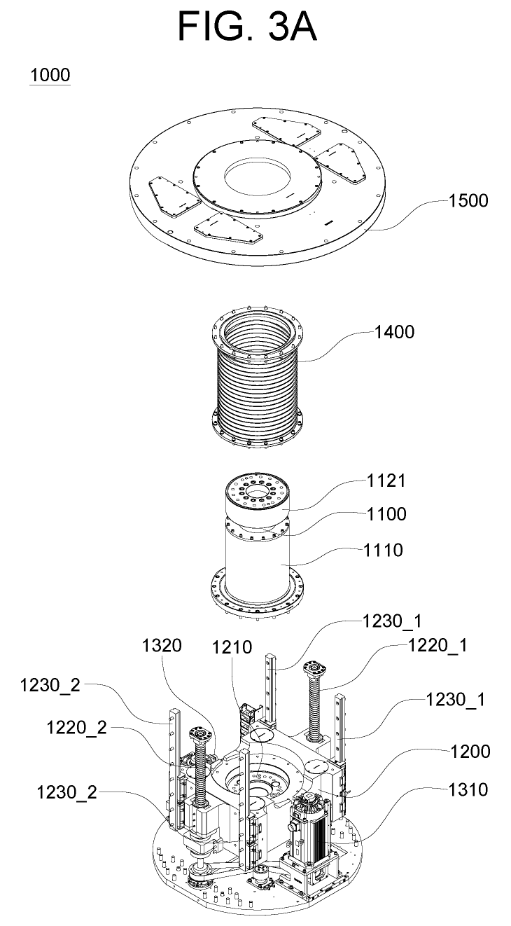

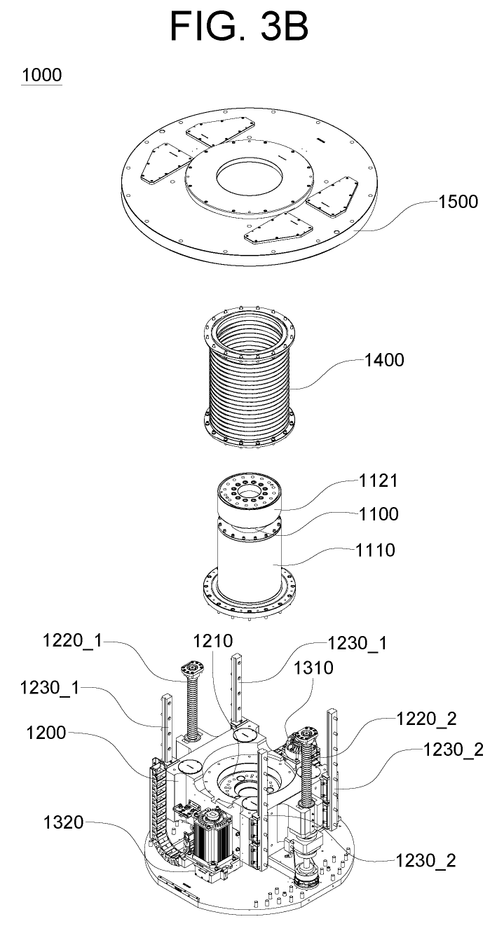

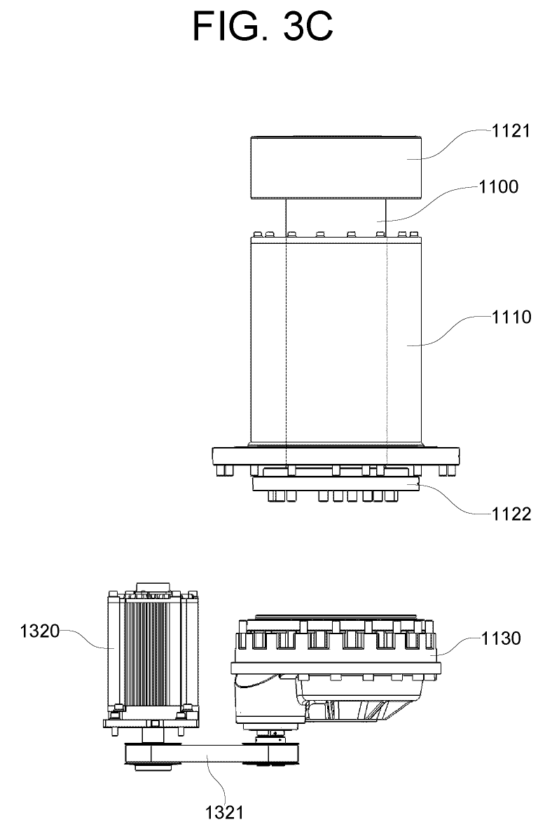

As an example, the elevating robot 1000 may be described in more detail by referring to FIGS. 3A to 3C as follows.

The elevating robot 1000 may include an elevating plate 1200 formed in a lower part of the vacuum chamber VC and configured to move vertically as an elevation driving unit. An a-th vertical through—hole 1210 may be formed in an a-th center area of the elevating plate 1200.

Also, the elevating robot 1000 may include the elevating shaft 1100 through which an a-th hollow hole is formed, wherein the elevating shaft 1000 is rotatably coupled with the a-th vertical through—hole 1210.

As an example, a support sleeve 1110 is fixedly coupled with the a-th vertical through-hole 1210 in a vertical direction, and the elevating shaft 1100 may be installed inside the support sleeve 1110. Herein, an upper part of the elevating shaft 1100 may be coupled with an upper flange 1121, and a lower part of the elevating shaft 1100 may be coupled with a lower flange 1122. However, the present disclosure is not limited thereto, and various structures in which the elevating shaft 1100 is rotatably coupled with the a-th vertical through-hole 1210 may be adopted.

Meanwhile, the elevation driving unit of the elevating robot 1000 may include a first screw shaft 1220_1 coupled with a one-side surface of the elevating plate 1200 by at least one screw nut and formed in the vertical direction, and a second screw shaft 1220_2 coupled with an opposite-side surface of the elevating plate 1200 by at least one screw nut and formed in the vertical direction. Herein, the one-side surface and the opposite-side surface of the elevating plate 1200 may be symmetrical to each other with respect to the a-th vertical through-hole 1210, but the present disclosure is not limited thereto.

In addition, the elevation driving unit of the elevating robot 1000 may include an a1-st driving motor 1310 capable of providing driving force for rotating the first screw shaft 1220_1 and the second screw shaft 1220_2.

Herein, each of timing belts may be used to transmit the driving force of the a1-st driving motor 1310 to the first screw shaft 1220_1 and the second screw shaft 1220_2, and may be coupled with timing pulleys which are respectively coupled with a driving shaft of the a1-st driving motor 1310, the first screw shaft 1220_1 and the second screw shaft 1220_2. However, although it is described that a transmission of the driving force between the a1-st driving motor 1310 and the first screw shaft 1220_1 and a transmission of the driving force between the a1-st driving motor 1310 and the second screw shaft 1220_2 are performed by the pulleys, the present disclosure is not limited thereto, and various methods for transmitting the driving force, such as a method using gears, may be adopted.

Accordingly, in the elevation driving unit of the elevating robot 1000, the first screw shaft 1220_1 and the second screw shaft 1220_2 may be rotated according to an operation of the a1-st driving motor 1310, and accordingly, the elevating plate 1200 is moved vertically in response to a rotation direction of the a1-st driving motor 1310, to thereby allow the elevating shaft 1100 to travel in the vertical direction.

Also, the elevation driving unit of the elevating robot 1000 may include at least one first sliding guide 1230_1, formed on the one-side surface of the elevating plate 1200, which is configured to support a direction of the vertical movement of the elevating plate 1200; and at least one second sliding guide 1230_2, formed on the opposite-side surface of the elevating plate 1200, which is configured to support the direction of the vertical movement of the elevating plate 1200. As another example, a plurality of the sliding guides may be formed at each side surface in order to support the vertical movement of the elevating plate 1200 more stably.

In addition, the elevating plate 1200 may be fixedly coupled with an a2-nd driving motor 1320 capable of providing driving force for rotating the elevating shaft 1100.

Herein, timing belts 1321 may be used to transmit the driving force of the a2-nd driving motor 1320 to the elevating shaft 1100, and may be coupled with timing pulleys, wherein the timing pulleys may be respectively coupled with a driving shaft of the a2-nd driving motor 1320 and an input shaft of an a-th speed reducer. Herein, an output shaft of the a-th speed reducer may be fixedly coupled with the lower part of the elevating shaft 1100, and preferably, may be fixedly coupled with the lower flange 1122 which is fixedly coupled with the lower part of the elevating shaft 1100. Meanwhile, although it is described that transmission of the driving force between the a2-nd driving motor 1320 and the elevating shaft 1100 is performed by the pulleys, the present disclosure is not limited thereto, and various methods for transmitting the driving force, such as a method using gears, may be adopted.

Accordingly, in the elevation driving unit of the elevating robot 1000, the elevating shaft 1100 may be rotated according to an operation of the a2-nd driving motor 1320.

Also, the elevating robot 1000 may be sealably coupled with the vacuum chamber through-hole of the vacuum chamber VC by using an a-th cover 1500. Herein, the a-th cover 1500 is configured to form a through-hole into which the elevating shaft 1100 may be inserted.

In addition, the elevating robot 1000 can include a bellows 1400 in which the elevating shaft 1100 is inserted. Herein, a one-end of the bellows 1400 is coupled with a lower region of the elevating plate 1200, preferably, a lower region of the support sleeve 1110 into which the elevating shaft 1100 is inserted, and an opposite-end of the bellows 1400 is coupled with the a-th cover 1500. Through this, the vacuum chamber VC may be maintained as a vacuum state sealed from the outer circumstance by the bellows 1400.

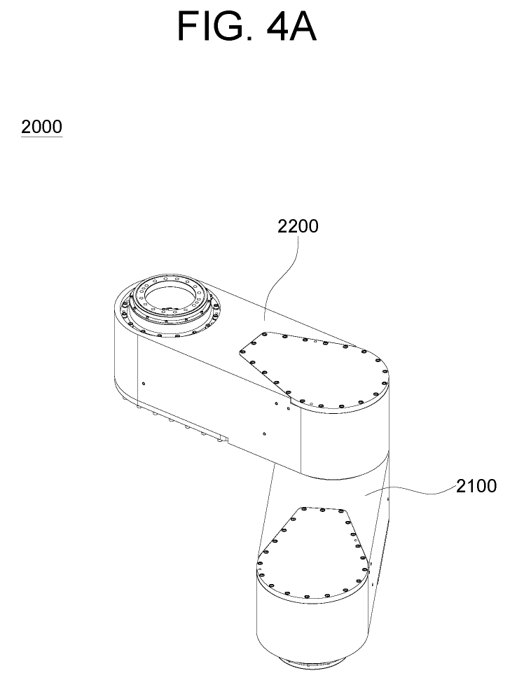

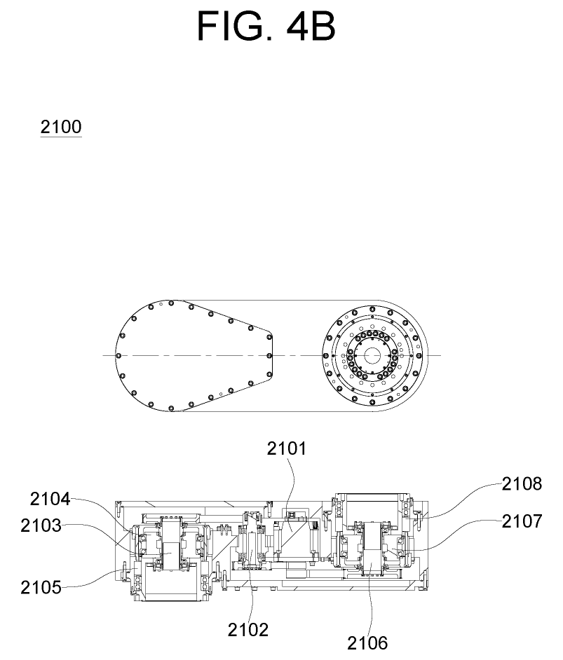

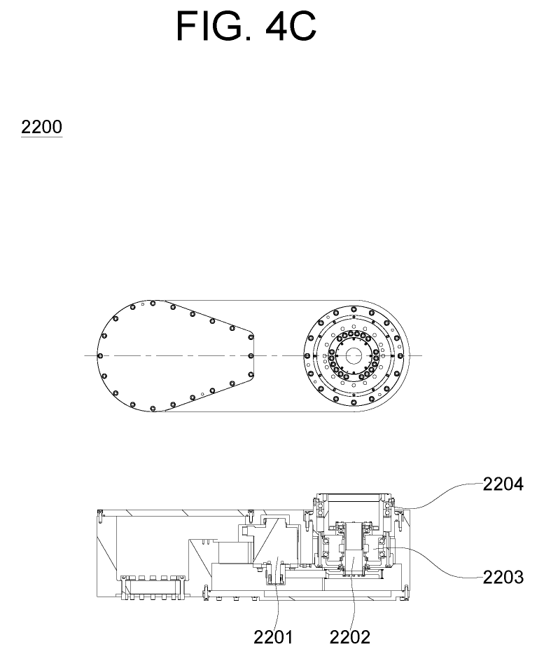

Next, the travel robot 2000 in the substrate transfer apparatus may be described in more detail by referring to FIGS. 4A to 4C as follows.

FIGS. 4A to 4C are drawings schematically illustrating the travel robot 2000 in the substrate transfer apparatus in accordance with one example embodiment of the present disclosure. Herein, the travel robot 2000 may include a b1-st travel link arm 2100 and a b2-nd travel link arm 2200.

The b1-st travel link arm 2100 includes a sealed inner space, and a b1-st driving motor 2101 and a b-th speed reducer 2102 which is interlocked with the b1-st driving motor 2101 to reduce a rotational speed of the b1-st driving motor 2101 by half are installed in the sealed inner space of the b1-st travel link arm 2100.

In addition, a (b1_1)-st driving shaft 2103 interlocked with the b-th speed reducer 2102 and a (b1_1)-st output shaft 2104 interlocked with the (b1_1)-st driving shaft 2103 are sealingly installed on a b1-st one-end area of the b1-st travel link arm 2100, wherein a (b1_1)-st hollow hole is formed through the (b1_1)-st driving shaft 2103. Also, the (b1_1)-st output shaft 2104, which is installed in the b1-st one-end area of the b1-st travel link arm 2100, may be fixedly coupled with the elevating shaft 1100 of the elevating robot 1000. Herein, a (b1_1)-st linking member 2105 is a tube-shaped shaft and may be used for coupling the (b1_1)-st output shaft 2104 with the elevating shaft 1100. Also, a length of the (b1_1)-st linking member 2105 is same as or larger than a distance between the (b1_1)-st output shaft 2104 of the b1-st travel link arm 2100 and the elevating shaft 1100 of the elevating robot 1000, specifically at the position where the elevating robot 1000 is coupled with the b1-st travel link arm 2100 of the travel robot 2000, and each of the two-ends of the (b1_1)-st linking member 2105 can be fixedly coupled with each of the elevating shaft 1100 of the elevating robot 1000 and the (b1_1)-st output shaft 2104 of the b1-st travel link arm 2100.

In addition, a (b1_2)-nd driving shaft 2106 interlocked with the b1-st driving motor 2101 and a (b1_2)-nd output shaft 2107 interlocked with the (b1_2)-nd driving shaft 2106 are sealingly installed on a b1-st opposite-end area of the b1-st travel link arm 2100, wherein a (b1_2)-nd hollow hole is formed through the (b1_2)-nd driving shaft 2106.

Herein, the interlocking between the b1-st driving motor 2101 and the b-th speed reducer 2102, the interlocking between the b-th speed reducer 2102 and the (b1_1)-st driving shaft 2103, and the interlocking between the b1-st driving motor 2101 and the (b1_2)-nd driving shaft 2106 may be achieved by pulley method, respectively, however, the present disclosure is not limited thereto. For example, various methods, such as a method using gears, etc. may be adopted to transmit a rotational force. Also, not only the (b1_1)-st driving shaft 2103 with the (b1_1)-st output shaft 2104 but also the (b1_2)-nd driving shaft 2106 with and the (b1_2)-nd output shaft 2107 can be formed by speed reducers each of which has a same reduction ratio. In addition, the (b1_1)-st output shaft 2104 and the (b1_2)-nd output shaft 2107 can be driven with opposite rotation directions.

Further, the b2-nd travel link arm 2200 includes a sealed inner space, and a b2-nd driving motor 2201 is installed in the sealed inner space of the b2-nd travel link arm 2200.

In addition, a b2-nd one-end area of the b2-nd travel link arm 2200 may be fixedly coupled with the (b1_2)-nd output shaft 2107 of the b1-st travel link arm 2100. Herein, a (b1_2)-nd linking member 2108 is a tube-shaped shaft and may be used for coupling the b2-nd one-end area of the b2-nd travel link arm 2200 with the (b1_2)-nd output shaft 2107 of the b1-st travel link arm 2100. Also, a length of the (b1_2)-nd linking member 2108 is same as or larger than a distance between the b2-nd one-end area of the b2-nd travel link arm 2200 and the (b1_2)-nd output shaft 2107 of the b1-st travel link arm 2100, specifically at the position where the b2-nd one-end area of the b2-nd travel link arm 2200 is coupled with the (b1_2)-nd output shaft 2107 of the b1-st travel link arm 2100, and each of the two-ends of the (b1_2)-nd linking member 2108 can be fixedly coupled with each of the b2-nd one-end area of the b2-nd travel link arm 2200 and the (b1_2)-nd output shaft 2107 of the b1-st travel link arm 2100.

In addition, a b2-nd driving shaft 2202 interlocked with the b2-nd driving motor 2201 and a b2-nd output shaft 2203 interlocked with the b2-nd driving shaft 2202 are sealingly installed on a b2-nd opposite-end area of the b2-nd travel link arm 2200, wherein a b2-nd hollow hole is formed through the b2-nd driving shaft 2202.

Herein, the interlocking between the b2-nd driving motor 2201 and the b2-nd driving shaft 2202 may be achieved by pulley method, respectively, however, the present disclosure is not limited thereto. For example, various methods, such as a method using gears, etc. may be adopted to transmit a rotational force. Also, the b2-nd driving shaft 2202 with b2-nd output shaft 2203 can be formed by speed reducers each of which has a same reduction ratio.

In the travel robot 2000 configured as described above, by an operation of the b1-st driving motor 2101 installed in the b1-st travel link arm 2100, the b2-nd opposite-end area of the b2-nd travel link arm 2200, preferably a central axis of the b2-nd driving shaft 2202 installed in the b2-nd opposite-end area of the b2-nd travel link arm 2200 may travel linearly with respect to the b1-st one-end area of the b1-st travel link arm 2100, preferably with respect to a central axis of the (b1_1)-st driving shaft 2103 installed in the b1-st one-end area of the b1-st travel link arm 2100, to thereby allow the transfer robot 3000 coupled with the travel robot 2000 to travel. Further, by an operation of the b2-nd driving motor 2201 installed in the b2-nd travel link arm 2200, the transfer robot 3000 coupled with the travel robot 2000 may be rotated.

Also, the transfer robot 3000 coupled with the travel robot 2000 may travel linearly according to the operation of the b1-st driving motor 2101 installed in the b1-st travel link arm 2100 of the travel robot 2000, to thereby determine a transfer position of the transfer robot 3000 for transferring the substrate. Further, the transfer robot 3000 may rotate according to the operation of the b2-nd driving motor 2201 installed in the b2-nd travel link arm 2200 of the travel robot 2000, to thereby determine a transfer direction of the transfer robot 3000 for transferring the substrate.

Herein, the b1-st driving motor 2101 and the b2-nd driving motor 2201 of the travel robot 2000 may operate sequentially to determine the transfer position and the transfer direction of the transfer robot 3000, or may operate simultaneously to determine the transfer position and the transfer direction of the transfer robot 3000. In addition, the elevation driving unit of the elevating robot 1000 and the b2-nd driving motor 2201 of the travel robot 2000 may operate sequentially to determine the travel direction of the travel robot 2000 and the transfer direction of the transfer robot 3000, or may operate simultaneously to determine the travel direction of the travel robot 2000 and the transfer direction of the transfer robot 3000. However, the present disclosure is not limited thereto, and the elevation driving unit of the elevating robot 1000, the b1-st driving motor 2101 of the travel robot 2000, and the b2-nd driving motor 2201 of the travel robot 2000 may operate individually, or at least two or more thereof may operate simultaneously, to thereby determine the travel direction of the travel robot 2000, the transfer position of the transfer robot 3000, and the transfer direction of the transfer robot 3000.

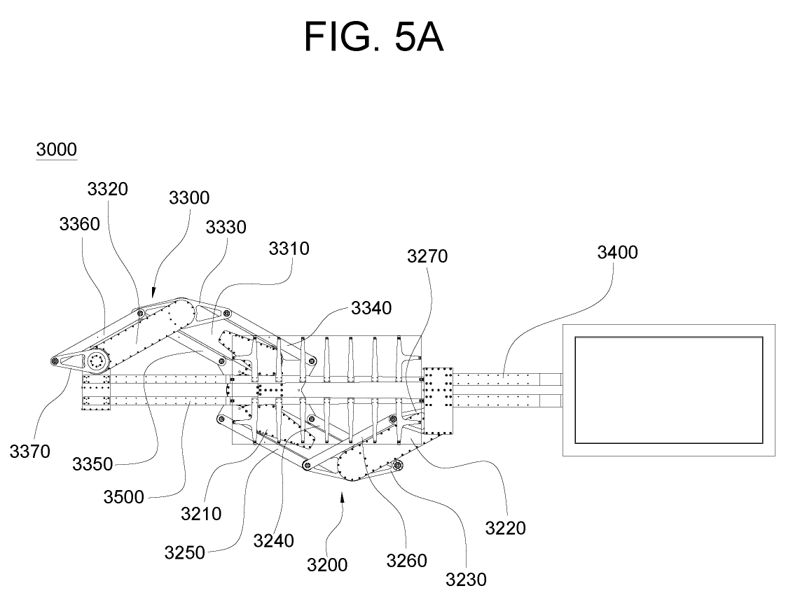

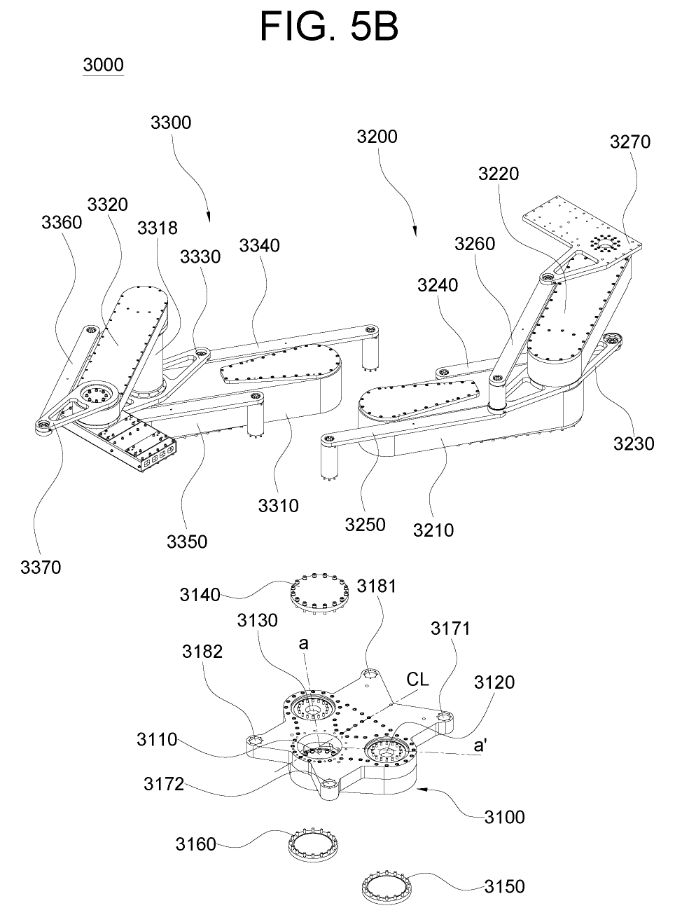

Next, the transfer robot 3000 in the substrate transfer apparatus may be described in more detail by referring to FIGS. 5A to 8 as follows.

By referring to FIGS. 5A and 5B, the transfer robot 3000 may include a transfer arm platform 3100 coupled with the b2-nd driving shaft 2202, and a first transfer arm part 3200 and a second transfer arm part 3300 coupled with the transfer arm platform 3100. Herein, the b2-nd driving shaft 2202 is installed in the b2-th opposite-end area of the b2-nd travel link arm of the travel robot 2000, and each of the first transfer arm part 3200 and the second transfer arm part 3300 is coupled with each of a first end-effector 3400 and a second end-effector 3500 configured to support the substrate. For reference, FIG. 5A illustrates a state in which a mask for performing photolithography on the substrate is supported by the first end-effector 3400 and the substrate is supported by the second end-effector 3500, and FIG. 5B illustrates a state in which forks capable of supporting the substrates are deleted from the first end-effector 3400 and the second end-effector 3500.

Through this, the transfer robot 3000 may travel to a particular position within the vacuum chamber VC by an operation of the travel robot 2000. Further, on condition that the first end-effector 3400 or the second end-effector 3500 is located at a loading position or an unloading position of the substrate by the vertical movement of the elevating robot 1000, the first end-effector 3400 or the second end-effector 3500 may load or unload the substrate according to an operation of the first transfer arm part 3200 or the second transfer arm part 3300.

Further, the transfer arm platform 3100 may include a c0-th coupling hole 3110 formed at a c-th center area which is a specific area on a center line CL, wherein the center line CL compartmentalize the transfer arm platform 3100 based on a linear movement direction of the first transfer arm part 3200 or the second transfer arm part 3300, i.e., based on a linear movement direction of the substrate moved by the transfer robot 3000; a c1-st coupling hole 3120 formed at a c-th one-end area of a one-side area with respect to the center line CL; and a c2-nd coupling hole 3130 formed at a c-th opposite-end area of an opposite-side area with respect to the center line CL corresponding to the c-th one-end area.

Further, in the transfer arm platform 3100, a (1_1)-st blade 3171 and a (1_2)-nd blade 3172 for a link connection are formed respectively at a forward part and a backward part of the c1-st coupling hole 3120, and a (2_1)-st blade 3181 and a (2_2)-nd blade 3182 for a link connection are formed respectively at a forward part and a backward part of the c2-nd coupling hole 3130.

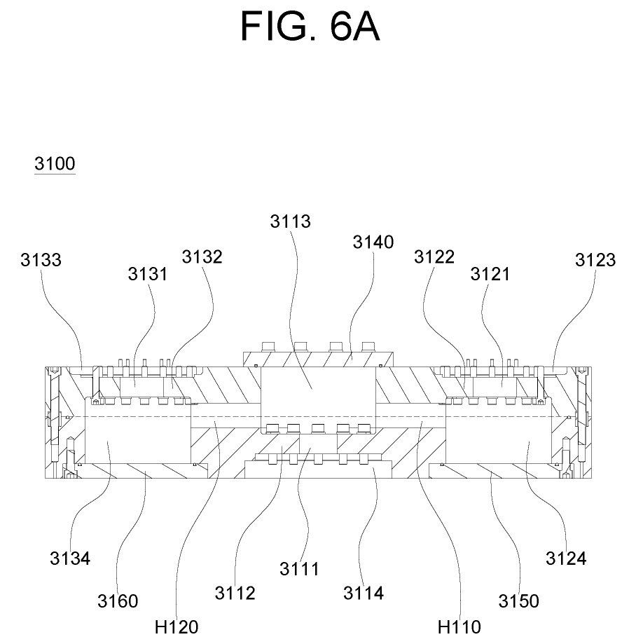

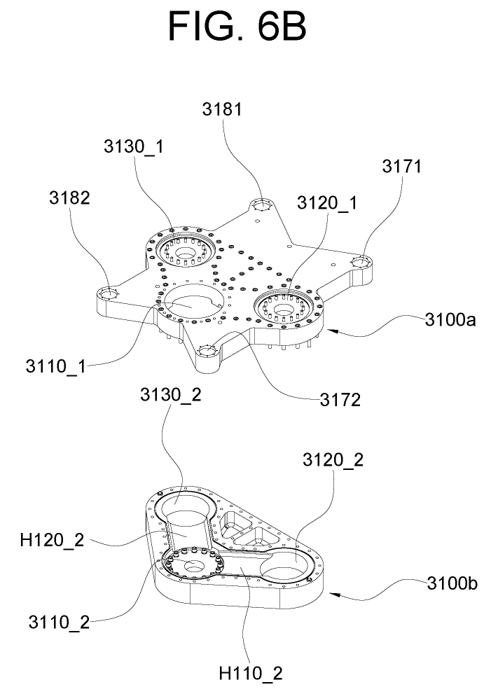

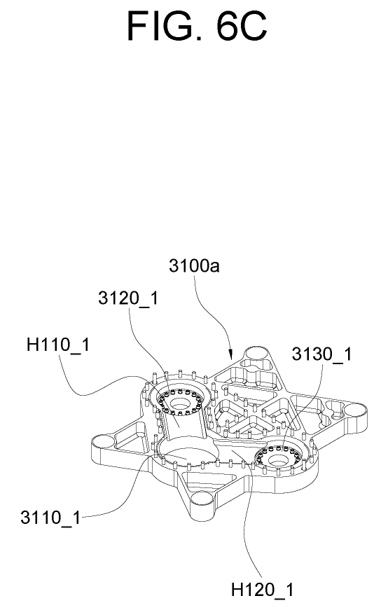

Herein, referring to FIG. 6A, a c0-th stopping member 3112, through which a c0-th vertical through-hole 3111 corresponding to the b2-nd hollow hole of the b2-nd driving shaft 2202 of the b2-nd travel link arm 2200 of the travel robot 2000 is formed at the c-th center area, compartmentalizes the c0-th coupling hole 3110 (shown in FIG. 5B) of the transfer arm platform 3100 into a c0-th upper space 3113 and a c0-th lower space 3114, wherein the c0-th upper space 3113 is sealed by a c0-th cover 3140.

In addition, a c1-st stopping member 3122, through which a c1-st vertical through-hole 3121 is formed at the c-th one-end area, compartmentalize the c1-st coupling hole 3120 (shown in FIG. 5B) of the transfer arm platform 3100 into a c1-st upper space 3123 and a c1-st lower space 3124 which is sealed by a c1-st cover 3150.

Further, a c2-nd stopping member 3132, through which a c2-nd through-hole 3131 is formed at the c-th opposite-end area, compartmentalizes the c2-nd coupling hole 3130 (shown in FIG. 5B) of the transfer arm platform 3100 into a c2-nd upper space 3133 and a c2-nd lower space 3134 which is sealed by a c2-nd cover 3160.

Also, the transfer arm platform 3100 may include a wiring hole for introducing wiring to the first transfer arm part 3200 and the second transfer arm part 3300 through the b2-nd hollow hole of the b2-nd driving shaft 2202 of the b2-nd travel link arm 2200 of the travel robot 2000.

That is, the transfer arm platform 3100 may include (i) a c1-st wiring hole H110 connecting the c0-th upper space 3113 and the c1-st lower space 3124 and (ii) a c2-nd wiring hole H120 connecting the c0-th upper space 3113 and the c2-nd lower space 3134.

As an example, referring to FIGS. 6B and 6C in addition to the FIG. 6A, the transfer arm platform 3100 may be formed by combining an upper plate 3100a and a lower plate 3100b with each other, wherein the upper plate 3100a includes the (1_1)-st blade 3171, the (1_2)-nd blade 3172, the (2_1)-st blade 3181 and the (2_2)-nd blade 3182.

A c0-th upper coupling hole 3110_1, which is a part of the c0-th coupling hole, is formed at the c-th central area of the upper plate 3100a, a c1-st upper coupling hole 3120_1, which is a part of the c1-st coupling hole, is formed at the c-th one-end area of the upper plate 3100a, and a c2-nd upper coupling hole 3130_1, which is a part of the c2-nd coupling hole, is formed at the c-th opposite-end area of the upper plate 3100a.

Further, a c1-st stopping member 3122, through which the c1-st vertical through-hole 3121 is formed inside the c1-st upper coupling hole 3120_1, compartmentalize an inner space of the c1-st upper coupling hole 3120_1, and a c2-nd stopping member 3132, through which the c2-nd vertical through-hole 3131 is formed inside the c2-nd upper coupling hole 3130_1, compartmentalize an inner space of the c2-nd upper coupling hole 3130_1.

Also, a c1-st upper wiring slot H110_1 and a c2-nd upper wiring slot H120_1 are formed at a lower surface of the upper plate 3100a, wherein the c1-st upper wiring slot H110_1 connects an inner space of the c0-th upper coupling hole 3110_1 with a lower space of the c1-st upper coupling hole 3120_1, and the c2-nd upper wiring slot H120_1 connects the inner space of the c0-th upper coupling hole 3110_1 with a lower space of the c2-nd upper coupling hole 3130_1.

Meanwhile, a c0-th lower coupling hole 3110_2, which is another part of the c0-th coupling hole, is formed at the c-th central area of the lower plate 3100b, and a c1-st lower coupling hole 3120_2, which is another part of the c1-st coupling hole, is formed at the c-th one-end area of the lower plate 3100b, and a c2-nd lower coupling hole 3130_2, which is another part of the c2-nd coupling hole, is formed at the c-th opposite-end area of the lower plate 3100b.

Also, a c0-th stopping member 3112, through which the c0-th vertical through-hole 3111 is formed inside the c0-th lower coupling hole 3110_2, compartmentalize an inner space of the c0-th lower coupling hole 3110_2.

In addition, a c1-st lower wiring slot H110_2 and a c2-nd lower wiring slot H120_2 are formed in an upper surface of the lower plate 3100b, wherein the c1-st lower wiring slot H110_2 connects an upper space of the c0-th lower coupling hole 3110_2 with an inner space of the c1-st lower coupling hole 3120_2, and the c2-nd lower wiring slot H120_2 connects the upper space of the c0-th lower coupling hole 3110_2 with an inner space of the c2-nd lower coupling hole 3130_2.

Thus, by coupling the upper plate 3100a and the lower plate 3100b, the c0-th upper coupling hole 3110_1 and the c0-th lower coupling hole 3110_2 are combined with each other thereby forming the c0-th coupling hole 3110, the c1-st upper coupling hole 3120_1 and the c1-st lower coupling hole 3120_2 are combined with each other thereby forming the c1-st coupling hole 3120, and the c2-nd upper coupling hole 3130_1 and the c2-nd lower coupling hole 3130_2 are combined with each other thereby forming the c2-nd coupling hole 3130. Also, by coupling the upper plate 3100a and the lower plate 3100b, the c1-st upper wiring slot H110_1 and the c1-st lower wiring slot H110_2 are combined with each other thereby forming the c1-st wiring hole H110, and the c2-nd upper wiring slot H120_1 and the c2-nd lower wiring slot H120_2 are combined with each other thereby forming the c2-nd wiring hole H120.

Referring FIGS. 5A and 5B again, the transfer arm platform 3100 may be coupled with the travel robot 2000. In detail, the b2-nd output shaft installed in the b2-nd opposite-end area of the b2-nd travel link arm 2200 of the travel robot 2000 may be inserted into the c0-th lower space of the c0-th coupling hole 3110, thereby allowing the b2-nd output shaft installed in the b2-nd opposite-end area of the b2-nd travel link arm 2200 of the travel robot 2000 to be fixedly coupled with the c0-th stopping member 3112. Herein, a b2-nd linking member 2204 (shown in FIG. 4C) is a tube-shaped shaft and may be used for coupling the b2-nd output shaft with the c0-th stopping member 3112. Also, a length of the b2-nd linking member 2204 is same as or larger than a distance between the b2-nd output shaft and the c0-th stopping member 3112, specifically at the position where the travel robot 2000 is coupled with the transfer arm platform 3100, and each of the two-ends of the b2-nd linking member 2204 can be fixedly coupled with each of the b2-nd output shaft and the c0-th stopping member 3112.

Accordingly, exposure to an external environment through the b2-nd hollow hole of the b2-nd driving shaft 2202 of the b2-nd travel link arm 2200 of the travel robot 2000 may be sealed away, at the c0-th coupling hole 3110, from the vacuum environment of the inside of the vacuum chamber VC.

Also, the (1_1)-st transfer link arm 3210 of the first transfer arm part 3200 can be coupled with the c1-st coupling hole 3120 of the transfer arm platform 3100, and the (2_1)-st transfer link arm 3310 of the second transfer arm part 3300 can be coupled with the c2-nd coupling hole 3130 of the transfer arm platform 3100.

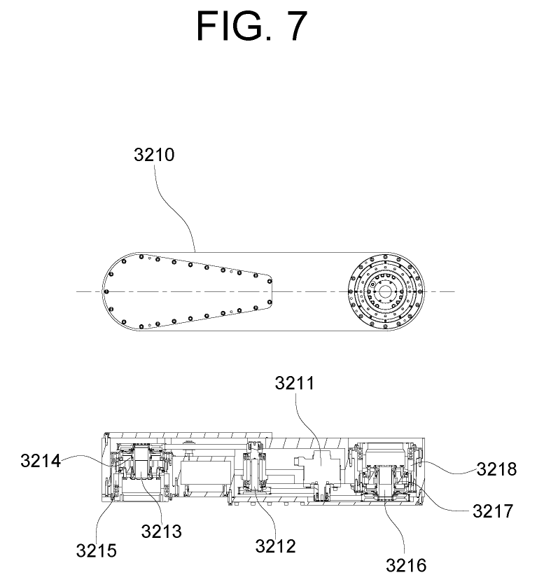

Herein, referring to FIG. 7, the (1_1)-st transfer link arm 3210 of the first transfer arm part 3200 has a sealed inner space where the c1-st driving motor 3211 and the c1-st speed reducer 3212 are installed, wherein the c1-st speed reducer 3212 is interlocked with the c1-st driving motor 3211 to reduce a rotational speed of the c1-st driving motor 3211 by half.

Also, a (c1_1)-st driving shaft 3213 interlocked with the c1-st speed reducer 3212 and a (c1_1)-st output shaft 3214 interlocked with the (c1_1)-st driving shaft 3213 may be sealably installed on a (c1_1)-st one-end area of the (1_1)-st transfer link arm 3210, wherein a (c1_1)-st hollow hole is formed through the (c1_1)-st driving shaft 3213, and a (c1_2)-nd driving shaft 3216 interlocked with the c1-st driving motor 3211 and a (c1_2)-nd output shaft 3217 interlocked with the (c1_2)-nd driving shaft 3216 may be sealably installed on a (c1_1)-st opposite-end area of the (1_1)-st transfer link arm 3210, wherein a (c1_2)-nd hollow hole is formed through the (c1_2)-nd driving shaft 3216. Herein, the interlocking between the c1-st driving motor 3211 and the c1-st speed reducer 3212, the interlocking between the c1-st speed reducer 3212 and the (c1_1)-st driving shaft 3213, and the interlocking between the c1-st driving motor 3211 and the (c1_2)-nd driving shaft 3216 may be achieved by pulley method, respectively, however, the present disclosure is not limited thereto. For example, various methods, such as a method using gears, etc. may be adopted to transmit a rotational force. Also, not only the (c1_1)-st driving shaft 3213 with the (c1_1)-st output shaft 3214 but also the (c1_2)-nd driving shaft 3216 with the (c1_2)-nd output shaft 3217 can be formed by speed reducers each of which has a same reduction ratio. In addition, the (c1_1)-st output shaft 3214 and the (c1_2)-nd output shaft 3217 can be driven with opposite rotation directions.

Referring FIGS. 5A and 5B again, the (c1_1)-st output shaft may be inserted into the c1-st upper space of the c1-st coupling hole 3120 of the transfer arm platform 3100 to thereby be fixedly coupled with the c1-st stopping member 3122. Herein, the (c1_1)-st output shaft is installed on a (c1_1)-st one-end area of the (1_1)-st transfer link arm 3210 of the first transfer arm part 3200.

Herein, a c1-st linking member 3125 (shown in FIG. 7) is a tube-shaped shaft and may be used for coupling the (c1_1)-st output shaft with the c1-st stopping member 3122. Herein, a length of the c1-st linking member 3125 is same as or larger than a distance between the (c1_1)-st output shaft and the c1-st stopping member 3122, specifically at the position where the transfer arm platform 3100 is coupled with the (1_1)-st transfer link arm 3210, and each of the two-ends of the c1-st linking member 3215 can be fixedly coupled with each of the (c1_1)-st output shaft and the c1-st stopping member 3122.

Also, a (c1_2)-nd output shaft of the (1_1)-st transfer link arm 3210 of the first transfer arm part 3200 may be fixedly coupled with a (c1_2)-nd one-end area of the (1_2)-nd transfer link arm 3220.

Herein, a first fixed coupling shaft 3218 (shown in FIG. 7) is a tube-shaped shaft and may be used for coupling the (c1_2)-nd output shaft of the (1_1)-st transfer link arm 3210 with the (c1_2)-nd one-end area of the (1_2)-nd transfer link arm 3220. Herein, a length of the first fixed coupling shaft is same as or larger than a distance between the (c1_2)-nd output shaft and the (c1_2)-nd one-end area, specifically at the position where the (1_1)-st transfer link arm 3210 is coupled with the (1_2)-nd transfer link arm 3220, and each of the two-ends of the first fixed coupling shaft can be fixedly coupled with each of the (c1_2)-nd output shaft and the (c1_2)-nd one-end area.

Also, a first common link arm 3230 may be installed at a position where the (1_1)-st transfer link arm 3210 and the (1_2)-nd transfer link arm 3220 are coupled, in other words, at a position where the (c1_2)-nd output shaft and the (c1_2)-nd one-end area are coupled.

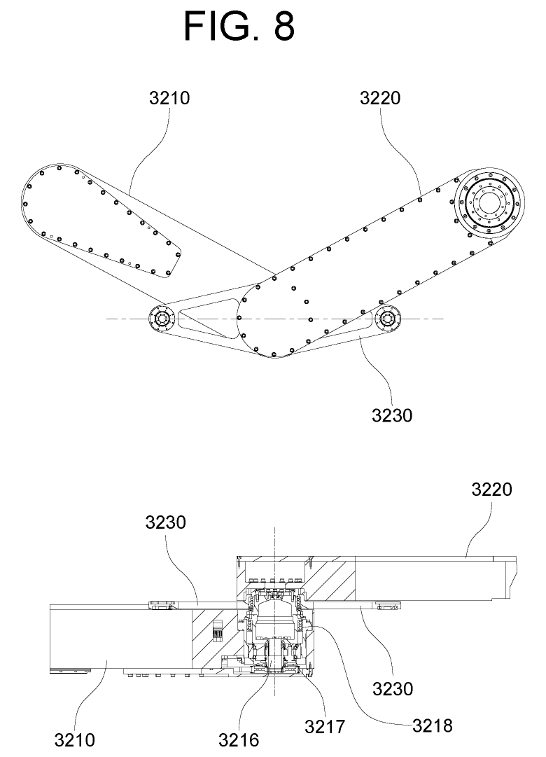

That is, by referring to FIG. 8, a c1-st center area of the first common link arm 3230 may be rotatably coupled with the first fixed coupling shaft 3218, wherein the first fixed coupling shaft 3218 combines the (c1_2)-nd output shaft 3217 with the (c1_2)-nd one-end area.

Also, by referring to FIGS. 5A and 5B again, the first transfer arm part 3200 may include a (1_1)-st subordinate link arm 3240 that is parallel to the (1_1)-st transfer link arm 3210, wherein a (c1_4)-th one-end area of the (1_1)-st subordinate link arm 3240 may be rotatably coupled with the (1_1)-st blade 3171 of the transfer arm platform 3100, and a (c1_4)-th opposite-end area of the (1_1)-st subordinate link arm 3240 may be rotatably coupled with a (c1_3)-rd one-end area of the first common link arm 3230.

Additionally, the first transfer arm part 3200 may include a (1_2)-nd subordinate link arm 3250 that is parallel to the (1_1)-st transfer link arm 3210, wherein a (c1_5)-th one-end area of the (1_2)-nd subordinate link arm 3250 may be rotatably coupled with the (1_2)-nd blade 3172 of the transfer arm platform 3100, and a (c1_5)-th opposite-end area of the (1_2)-nd subordinate link arm 3250 may be rotatably coupled with a (c1_3)-rd opposite-end area of the first common link arm 3230.

Accordingly, two single parallel links may be formed as a double parallel link, wherein each of the two single parallel links shares the (1_1)-st transfer link arm 3210 with each other.

In other words, one single parallel link is formed by a frame, an input link, a connecting arm and a follower. Herein, the frame is formed by two joints, wherein one joint is where the (c1_1)-st one-end area of the (1_1)-st transfer link arm 3210 is coupled with the c1-st coupling hole 3120 of the transfer arm platform 3100 and another joint is where the (c1_4)-th one-end area of the (1_1)-st subordinate link arm 3240 is coupled with the (1_1)-st blade 3171 of the transfer arm platform 3100. In addition, the input link is formed by the (1_1)-st transfer link arm 3210. Further, the connecting arm is formed by the first common link arm between two joints, wherein one joint is where the (c1_1)-st opposite-end area of the (1_1)-st transfer link arm 3210 is coupled with the c1-st center area of the first common link arm 3230 and another joint is where the (c1_3)-rd one-end area of the first common link arm 3230 is coupled with the (c1_4)-th opposite-end area of the (1_1)-st subordinate link arm 3240. Further, the follower is formed by the (1_1)-st subordinate link arm 3240. Herein, the frame is a concept that may or may not physically exist, and is a reference line or a reference plane that fixes one-end of the input link and one-end of the follower that constitute the parallel link. Thus, the frame mentioned below should be interpreted similarly.

Also, another single parallel link is formed by a frame, an input link, a connecting arm and a follower. Herein, the frame is formed by two joints, wherein one joint is where the (c1_1)-th one-end area of the (1_1)-st transfer link arm 3210 is coupled with the c1-st coupling hole 3120 of the transfer arm platform 3100 and another joint is where the (c1_5)-th one-end area of the (1_2)-nd subordinate link arm 3250 is coupled with the (1_2)-nd blade 3172 of the transfer arm platform 3100. In addition, the input link is formed by the (1_1)-st transfer link arm 3210. Further, the connecting arm is formed by the first common link arm between two joints, wherein one joint is where the (c1_1)-st opposite-end area of the (1_1)-st transfer link arm 3210 is coupled with the c1-st center area of the first common link arm 3230 and another joint is where the (c1_3)-rd opposite-end area of the first common link arm 3230 is coupled with the (c1_5)-th opposite-end area of the (1_2)-nd subordinate link arm 3250. Further, the follower is formed by the (1_2)-nd subordinate link arm 3250.

By means of such double parallel links, vibration and/or disturbance of the first end-effector 3400 during the movement along a substrate transfer route can be reduced.

In addition, the first transfer link arm part 3200 may include a (1_3)-st subordinate link arm 3260, which is parallel to the (1_2)-nd transfer link arm 3220, wherein a (c1_6)-th one-end area of the (1_3)-rd subordinate link arm 3260 is rotatably coupled with the (c1_3)-rd opposite-end area of the first common link arm 3230. Herein, a joint where the (c1_6)-th one-end area of the (1_3)-rd subordinate link 3260 is coupled with the (c1_3)-rd opposite-end area of the first common link arm 3230 may be formed at the same position with a joint where the (c1_5)-th opposite-end area of the (1_2)-rd subordinate link arm 3250 is coupled with the (c1_3)-rd opposite-end area of the first common link arm 3230, or may be formed at a different position.

Also, the first transfer link arm part 3200 may include a (1_4)-st subordinate link arm 3270, which is parallel to the first common link arm 3230, wherein the (c1_7)-th one-end area of the (1_4)-th subordinate link arm 3270 is rotatably coupled with the (c1_6)-th opposite-end area of the (1_3)-rd subordinate link arm 3260, and the (c1_7)-th opposite-end area of the (1_4)-th subordinate link arm 3270 is rotatably coupled with the (c1_2)-nd opposite-end area of the (1_2)-nd transfer link arm 3220.

In addition, the first transfer link arm 3200 may include the first end-effector 3400, wherein the first end-effector 3400 is fixed to the (c1_7)-th opposite-end area of the (1_4)-th subordinate link arm 3270, thereby supporting the substrate. For reference, FIG. 5B illustrates a plate formed integrally with the (1_4)-th subordinate link arm 3270, wherein the plate is used for fixing the forks of the first end-effector 3400 capable of supporting the substrate.

The first transfer arm part 3200 configured like above allows the first end-effector 3400 to move forward or backward by using each of the transfer arms and the subordinate arms along a straight path according to an operation of the c1-st driving motor 3211, thereby allowing the substrate to be loaded or unloaded at a predetermined position through the first end-effector 3400.

Also, by referring to FIGS. 5A and 5B again, the second transfer arm part 3300 may be configured similarly to the first transfer arm part 3200, and may be installed on the transfer arm platform 3100 so as to be symmetrical to the first transfer arm part 3200 with respect to the center line CL of the transfer arm platform 3100.

In other words, the (2_1)-st transfer link arm 3310 of the second transfer arm part 3300 has a sealed inner space where the c2-nd driving motor and the c2-nd speed reducer are installed, wherein the c2-nd speed reducer is interlocked with the c2-nd driving motor to reduce a rotational speed of the c2-nd driving motor by half.

Also, a (c2_1)-st driving shaft interlocked with the c2-nd speed reducer and a (c2_1)-st output shaft interlocked with the (c2_1)-st driving shaft may be sealably installed on a (c2_1)-st one-end area of the (2_1)-st transfer link arm 3310, wherein a (c2_1)-st hollow hole is formed through the (c2_1)-st driving shaft, and a (c2_2)-nd driving shaft interlocked with the c2-nd driving motor and a (c2_2)-nd output shaft interlocked with the (c2_2)-nd driving shaft may be sealably installed on a (c2_1)-st opposite-end area of the (2_1)-st transfer link arm 3310, wherein a (c2_2)-nd hollow hole is formed through the (c2_2)-nd driving shaft. Herein, the interlocking between the c2-nd driving motor and the c2-nd speed reducer, the interlocking between the c2-nd speed reducer and the (c2_1)-st driving shaft, and the interlocking between the c2-nd driving motor and the (c2_2)-nd driving shaft may be achieved by pulley method, respectively, however, the present disclosure is not limited thereto. For example, various methods, such as a method of using gears, etc. may be adopted to transmit a rotational force. Also, not only the (c2_1)-st driving shaft with the (c2_1)-st output shaft but also the (c2_2)-nd driving shaft with the (c2_2)-nd output shaft can be formed by speed reducers each of which has a same reduction ratio. In addition, the (c2_1)-st output shaft and the (c2_2)-nd output shaft can be driven with opposite rotation directions.

Also, the (c2_1)-st output shaft may be inserted into the c2-nd upper space 3133 of the c2-nd coupling hole 3130 of the transfer arm platform 3100 to be fixedly coupled with the c2-nd stopping member 3132. Herein, the (c2_1)-st output shaft is installed on a (c2_1)-st one-end area of the (2_1)-st transfer link arm 3310 of the second transfer arm part 3300.

Herein, a c2-nd linking member is a tube-shaped shaft and may be used for coupling the (c2_1)-st output shaft with the c2-nd stopping member 3132. Herein, a length of the c2-nd linking member is same as or larger than a distance between the (c2_1)-st output shaft and the c2-nd stopping member 3132, specifically at the position where the transfer arm platform 3100 is coupled with the (2_1)-st transfer link arm 3310, and each of the two-ends of the c2-nd linking member can be fixedly coupled with each of the (c2_1)-st output shaft and the c2-nd stopping member 3132.

Also, a (c2_2)-nd output shaft of the (2_1)-st transfer link arm 3310 of the second transfer arm part 3300 may be fixedly coupled with a (c2_2)-nd one-end area of the (2_2)-nd transfer link arm 3320.

Herein, a second fixed coupling shaft 3318 is a tube-shaped shaft and may be used for coupling the (c2_2)-nd output shaft of the (2_1)-st transfer link arm 3310 and the (c2_2)-nd one-end area of the (2_2)-nd transfer link arm 3320. Herein, a length of the second fixed coupling shaft 3318 is same as or larger than a distance between the (c2_2)-nd output shaft and the (c2_2)-nd one-end area, specifically at the position where the (2_1)-st transfer link arm 3310 is coupled with the (2_2)-nd transfer link arm 3320, and each of the two-ends of the second fixed coupling shaft 3318 can be fixedly coupled with each of the (c2_2)-nd output shaft and the (c2_2)-nd one-end area. Also, a height of the second fixed coupling shaft 3318, which connects the (2_1)-st transfer link arm 3310 with the (2_2)-nd transfer link arm 3320 of the second transfer arm part 3300, may be set as higher than a height of the first fixed coupling shaft which connects the (1_1)-st transfer link arm 3210 with the (1_2)-nd transfer link arm 3220 of the first transfer arm part 3200. Accordingly, the first end-effector 3400 of the first transfer arm part 3200 and the second end-effector 3500 of the second transfer arm part 3300 are positioned at different heights on a same transferring route. However, the present disclosure is not limited thereto. As another example, the height of the first fixed coupling shaft may be set as higher than a height of the second fixed coupling shaft.

Next, a second common link arm 3330 may be installed at a position where the (2_1)-st transfer link arm 3310 is coupled with the (2_2)-nd transfer link arm 3320, in other words, at a position where the (c2_2)-nd output shaft is coupled with the (c2_2)-nd one-end area.

That is, a c2-nd center area may be rotatably coupled with the second fixed coupling shaft, wherein the second fixed coupling shaft combines the (c2_2)-nd output shaft with the (c2_2)-nd one-end area.

In addition, the second transfer arm part 3300 may include the (2_1)-st subordinate link arm 3340 that is parallel to the (2_1)-st transfer link arm 3310, wherein a (c2_4)-th one-end area of the (2_1)-st subordinate link arm 3340 may be rotatably coupled with the (2_1)-st blade 3181 of the transfer arm platform 3100, and a (c2_4)-th opposite-end area of the (2_1)-st subordinate link arm 3340 may be rotatably coupled with a (c2_3)-rd one-end area of the second common link arm 3330.

Also, the second transfer arm part 3300 may include a (2_2)-nd subordinate link arm 3350 that is parallel to the (2_1)-nd transfer link arm 3310, wherein a (c2_5)-th one-end area of the (2_2)-nd subordinate link arm 3350 may be rotatably coupled with the (2_2)-nd blade 3182 of the transfer arm platform 3100, and a (c2_5)-th opposite-end area of the (2_2)-nd subordinate link arm 3350 may be rotatably coupled with a (c2_3)-rd opposite-end area of the second common link arm 3330.

Accordingly, two single parallel links may be formed as a double parallel link, wherein each of the two single parallel links shares the (2_1)-st transfer link arm 3310 with each other.

In other words, one single parallel link is formed by a frame, an input link, a connecting arm and a follower. Herein, the frame is formed by two joints, wherein one joint is where the (c2_1)-st one-end area of the (2_1)-st transfer link arm 3310 is coupled with the c2-nd coupling hole 3130 of the transfer arm platform 3100 and another joint is where the (c2_4)-th one-end area of the (2_1)-st subordinate link arm 3340 is coupled with the (2_1)-st blade 3181 of the transfer arm platform 3100. Further, the input link is formed by the (2_1)-st transfer link arm 3310. Further, the connecting arm is formed by the second common link arm 3330 between two joints, wherein one joint is where the (c2_1)-st opposite-end area of the (2_1)-st transfer link arm 3310 is coupled with the c2-nd center area of the second common link arm 3330 and another joint is where the (c2_3)-rd one-end area of the second common link arm 3330 is coupled with the (c2_4)-th opposite-end area of the (2_1)-st subordinate link arm 3340. Further, the follower is formed by the (2_1)-st subordinate link arm 3340.

Also, another single parallel link is formed by a frame, an input link, a connecting arm and a follower. Herein, the frame is formed by two joints, wherein one joint is where the (c2_1)-th one-end area of the (2_1)-st transfer link arm 3310 is coupled with the c2-nd coupling hole 3130 of the transfer arm platform 3100 and another joint is where the (c2_5)-th one-end area of the (2_2)-nd subordinate link arm 3350 is coupled with the (2_2)-nd blade 3182 of the transfer arm platform 3100. Further, the input link is formed by the (2_1)-st transfer link arm 3310. Further, the connecting arm is formed by the second common link arm 3330 between two joints, wherein one joint is where the (c2_1)-st opposite-end area of the (2_1)-st transfer link arm 3310 is coupled with the c2-nd center area of the second common link arm 3330 and another joint is where the (c2_3)-rd opposite-end area of the second common link arm 3330 is coupled with the (c2_5)-th opposite-end area of the (2_2)-nd subordinate link arm 3350. Further, the follower is formed by the (2_2)-nd subordinate link arm 3350.

By means of such a double parallel link, vibration and/or disturbance of the second end-effector 3500 during the movement along the transfer route can be reduced.

Also, the second transfer link arm part 3300 may include a (2_3)-rd subordinate link arm 3360, which is parallel to the (2_2)-nd transfer link arm 3320, wherein a (c2_6)-th one-end area of the (2_3)-rd subordinate link arm 3360 is rotatably coupled with the (c2_3)-rd opposite-end area of the second common link arm 3330. Herein, a joint where the (c2_6)-th one-end area of the (2_3)-rd subordinate link arm 3360 is coupled with the (c2_3)-rd opposite-end area of the second common link arm 3330 may be formed at the same position with a joint where the (c2_5)-th opposite-end area of the (2_2)-nd subordinate link arm 3350 is coupled with the (c2_3)-rd opposite-end area of the second common link arm 3330, or may be formed at a different position.

In addition, the second transfer link arm part 3300 may include a (2_4)-th subordinate link arm 3370, which is parallel to the second common link arm 3330, wherein the (c2_7)-th one-end area of the (2_4)-th subordinate link arm 3370 is rotatably coupled with the (c2_6)-th opposite-end area of the (2_3)-rd subordinate link arm 3360 and the (c2_7)-th opposite-end area of the (2_4)-th subordinate link arm 3370 is rotatably coupled with the (c2_2)-nd opposite-end area of the (2_2)-nd transfer link arm 3320.

Also, the second transfer link arm part 3300 may include the second end-effector 3500, wherein the second end-effector 3500 is fixed to the (c2_7)-th opposite-end area of the (2_4)-th subordinate link arm 3370, thereby supporting the substrate. For reference, FIG. 5B illustrates the plate formed separately with the (2_4)-th subordinate link arm 3370, wherein the plate is used for fixing the forks of the second end-effector 3500 capable of supporting the substrates. Herein, the plate for fixing the forks of the second end-effector 3500 capable of supporting the substrates is fixedly coupled with the (c2_7)-th opposite-end area of the (2_4)-th subordinate link arm 3370.

The second transfer arm part 3300 configured like above allows the second end-effector 3500 to move forward or backward by using each of the transfer arms and subordinate arms along a straight path according to an operation of the c2-nd driving motor, thereby allowing the substrate to be loaded or unloaded at a predetermined position through the second end-effector 3500.

Herein, the (c1_1)-st opposite-end area of the (1_1)-st transfer link arm 3210 of the first transfer arm part 3200 and the (c2_1)-st opposite-end area of the (2_1)-st transfer link arm 3310 of the second transfer arm part 3300 can be located in the same forward part or the backward part of the transfer arm platform 3100.

As another example, the (c1_1)-st opposite-end area of the (1_1)-st transfer link arm 3210 of the first transfer arm part 3200 can be located in the forward part of the transfer arm platform 3100 and the (c2_1)-st opposite-end area of the (2_1)-st transfer link arm 3310 of the second transfer arm part 3300 can be located in the backward part of the transfer arm platform 3100.

In addition, the c1-st wiring for the operation of the c1-st driving motor 3211 and the c2-nd wiring for the operation of the c2-nd driving motor can each be located in a sealed inner space inside the transfer robot 3000.

Herein, the c1-st wiring may be introduced into the c1-st driving motor 3211 through each of hollow holes of the elevating shaft 1100 of the elevating robot 1000, the (b1_1)-st driving shaft 2103 and the (b1_2)-nd driving shaft 2106 of the b1-st travel link arm 2100 of the travel robot 2000, the b2-nd driving shaft 2202 of the b2-nd travel link arm 2200 of the travel robot 2000, and the (c1_1)-st driving shaft 3213 of the transfer robot 3000, so as to prevent the c1-st wiring from being exposed to an inner space of the vacuum chamber VC, and the c2-nd wiring may be introduced into the c2-nd driving motor through each of hollow holes of the elevating shaft 1100 of the elevating robot 1000, the (b1_1)-st driving shaft 2103 and the (b1_2)-nd driving shaft 2106 of the b1-st travel link arm 2100 of the travel robot 2000, the b2-nd driving shaft 2202 of the b2-nd travel link arm 2200 of the travel robot 2000, and the (c2_1)-st driving shaft of the transfer robot 3000 so as to prevent the c2-nd wiring from being exposed to an inner space of the vacuum chamber VC. Meanwhile, the c1-st wiring and the c2-nd wiring may be respectively branched from the b2-nd driving shaft 2202 of the b2-nd travel link arm 2200 of the travel robot 2000 into the c1-st arm part 3200 and the c2-nd arm part 3300, through the c1-st wiring hole and the c2-nd wiring hole formed in the transfer arm platform 3100.

The present disclosure has an effect of providing a more compact substrate transfer apparatus capable of improving an efficiency related to an installation area and an installation height.

The present disclosure has another effect of providing the substrate transfer apparatus capable of minimizing vibration and/or disturbance with a simple structure and minimizing changes in a pose of the substrate transfer apparatus due to thermal expansion.

The present disclosure has still another effect of providing the substrate transfer apparatus capable of fundamentally preventing a particle generation within a vacuum chamber and having a vacuum sealing structure.

The present disclosure has still yet another effect of providing the substrate transfer apparatus capable of reducing manufacturing and operating costs of a substrate manufacturing equipment.

As seen above, the present invention has been explained by specific matters such as detailed components, limited embodiments, and drawings. They have been provided only to help more general understanding of the present invention. It, however, will be understood by those skilled in the art that various changes and modification may be made from the description without departing from the spirit and scope of the invention as defined in the following claims. Accordingly, the thought of the present invention must not be confined to the explained embodiments, and the following patent claims as well as everything including variations equal or equivalent to the patent claims pertain to the category of the thought of the present invention.

What is claimed is:

1. A substrate transfer apparatus that transfers a substrate in a vacuum chamber, comprising:
an elevating robot including: (i) an elevating shaft through which an a-th hollow hole is formed, and (ii) an elevation driving unit for moving vertically and rotating the elevating shaft, wherein the elevating robot is sealably coupled with a vacuum chamber through-hole formed in a lower region of the vacuum chamber;
a travel robot including: (i) a b1-st travel link arm, wherein a b1-st driving motor and a b-th speed reducer which is interlocked with the b1-st driving motor to reduce a rotational speed of the b1-st driving motor by half are installed in a sealed inner space of the b1-st travel link arm, wherein a (b1_1)-st driving shaft which is interlocked with the b-th speed reducer and a (b1_1)-st output shaft which is interlocked with the (b1_1)-st driving shaft are sealingly installed on a b1-st one-end area of the b1-st travel link arm, wherein a (b1_1)-st hollow hole is formed through the (b1_1)-st driving shaft, wherein a (b1_2)-nd driving shaft interlocked with the b1-st driving motor and a (b1_2)-nd output shaft interlocked with the (b1_2)-nd driving shaft are sealingly installed on a b1-st opposite-end area of the b1-st travel link arm, wherein a (b1_2)-nd hollow hole is formed through the (b1_2)-nd driving shaft, and wherein the (b1_1)-st output shaft is fixedly coupled with the elevating shaft of the elevating robot, and (ii) a b2-nd travel link arm, wherein a b2-nd driving motor is installed in a sealed inner space of the b2-nd travel link arm, wherein a b2-nd one-end area of the b2-nd travel link arm is fixedly coupled with the (b1_2)-nd output shaft of the b1-st travel link arm, and wherein a b2-nd driving shaft interlocked with the b2-nd driving motor and a b2-nd output shaft interlocked with the b2-nd driving shaft are sealingly installed on a b2-nd opposite-end area of the b2-nd travel link arm, wherein a b2-nd hollow hole is formed through the b2-nd driving shaft; and
a transfer robot including: (i) a transfer arm platform, wherein the transfer arm platform has (i-1) a c0-th coupling hole formed at a c-th center area which is a specific area on a center line corresponding to a linear movement direction of the substrate to be transferred, wherein c0-th stopping member, through which a c0-th vertical through-hole corresponding to the b2-nd hollow hole of the b2-nd driving shaft of the b2-nd opposite-end area of the b2-nd travel link arm of the travel robot is formed, compartmentalizes the c0-th coupling hole into a c0-th upper space and a c0-th lower space, wherein the c0-th upper space is sealed by a c0-th cover, (i-2) a c1-st coupling hole formed at a c-th one-end area of a one-side area with respect to the center line, wherein a c1-st stopping member, through which a c1-st vertical through-hole is formed, compartmentalize the c1-st coupling hole into a c1-st upper space and a c1-st lower space which is sealed by a c1-st cover, (i-3) a c2-nd coupling hole formed at a c-th opposite-end area of an opposite-side area with respect to the center line corresponding to the c-th one-end area, wherein a c2-nd stopping member, through which a c2-nd vertical through-hole is formed, compartmentalizes the c2-nd coupling hole into a c2-nd upper space and a c2-nd lower space which is sealed by a c2-nd cover, (i-4) a (1_1)-st blade and a (1_2)-nd blade formed respectively at a forward part and a backward part of the c1-st coupling hole, and (i-5) a (2_1)-st blade and a (2_2)-nd blade formed respectively at the forward part and the backward part of the c2-nd coupling hole, and wherein the b2-nd output shaft of the b2-nd opposite-end area of the b2-nd travel link arm of the travel robot inserted into the c0-th lower space is fixedly coupled with the c0-th stopping member, (ii) a first transfer arm part, wherein the first transfer arm part has a (1_1)-st transfer link arm, a (1_2)-nd transfer link arm, a first common link arm, a (1_1)-st subordinate link arm which is parallel to the (1_1)-st transfer link arm, a (1_2)-nd subordinate link arm which is parallel to the (1_1)-st transfer link arm, a (1_3)-rd subordinate link arm which is parallel to the (1_2)-nd transfer link arm, a (1_4)-th subordinate link arm which is parallel to the first common link arm, and a first end-effector, wherein a c1-st driving motor and a c1-st speed reducer which is interlocked with the c1-st driving motor to reduce a rotational speed of the c1-st driving motor by half are installed in a sealed inner space of the (1_1)-st transfer link arm, wherein a (c1_1)-st driving shaft interlocked with the c1-st speed reducer and a (c1_1)-st output shaft interlocked with the (c1_1)-st driving shaft are sealingly installed on a (c1_1)-st one-end area of the (1_1)-st transfer link arm, wherein a (c1_1)-st hollow hole is formed through the (c1_1)-st driving shaft, wherein a (c1_2)-nd driving shaft interlocked with the c1-st driving motor and a (c1_2)-nd output shaft interlocked with the (c1_2)-nd driving shaft are sealingly installed on a (c1_1)-st opposite-end area of the (1_1)-st transfer link arm, wherein a (c1_2)-nd hollow hole is formed through the(c1_2)-nd driving shaft, wherein the (c1_1)-st output shaft of the (1_1)-st transfer link arm is fixedly coupled with a c1-st linking member that is inserted into the c1-st upper space of the transfer arm platform to be fixedly coupled with the c1-st stopping member, wherein a (c1_2)-nd one-end area of the (1_2)-nd transfer link arm is fixedly coupled with the (c1-2)-nd output shaft of the (1_1)-st transfer link arm through a first fixed coupling shaft, wherein a c1-st center area of the first common link arm is rotatably coupled with the first fixed coupling shaft, wherein a (c1_4)-th one-end area of the (1_1)-st subordinate link arm is rotatably coupled with the (1_1)-st blade of the transfer arm platform and a (c1_4)-th opposite-end area of the (1_1)-st subordinate link arm is rotatably coupled with a (c1_3)-rd one-end area of the first common link arm, wherein a (c1_5)-th one-end area of the (1_2)-nd subordinate link arm is rotatably coupled with the (1_2)-nd blade of the transform arm platform and a (c1_5)-th opposite-end area of the (1_2)-nd subordinate link arm is rotatably coupled with a (c1_3)-rd opposite-end area of the first common link arm, wherein (c1_6)-th one-end area of the (1_3)-rd subordinate link arm is rotatably coupled with a (c1_3)-rd opposite-end area of the first common link arm, wherein a (c1_7)-th one-end area of the (1_4)-th subordinate link arm is rotatably coupled with a (c1_6)-th opposite-end area of the (1_3)-rd subordinate link arm and a (c1_7)-th opposite-end area of the (1_4)-th subordinate link arm is rotatably coupled with the (c1_2)-nd opposite-end area of the (1_2)-nd transfer link arm, and wherein the first end-effector is fixed to the (c1_7)-th opposite-end area of the (1_4)-th subordinate link arm to thereby support the substrate, and (iii) a second transfer arm part, wherein the second transfer arm part has a (2_1)-st transfer link arm, a (2_2)-nd transfer link arm, a second common link arm, a (2_1)-st subordinate link arm which is parallel to the (2_1)-st transfer link arm, a (2_2)-nd subordinate link arm which is parallel to the (2_1)-st transfer link arm, a (2_3)-rd subordinate link arm which is parallel to the (2_2)-nd transfer link arm, a (2_4)-th subordinate link arm which is parallel to the second common link arm, and a second end-effector, wherein a c2-nd driving motor and a c2-nd speed reducer which is interlocked with the c2-nd driving motor to reduce a rotational speed of the c2-nd driving motor by half are installed in a sealed inner space of the (2_1)-st transfer link arm, wherein a (c2_1)-st driving shaft interlocked with the c2-nd speed reducer and a (c2_1)-st output shaft interlocked with the (c2_1)-st driving shaft are sealingly installed on a (c2_1)-st one-end area of the (2_1)-st transfer link arm, wherein a (c2_1)-st hollow hole is formed through the (c2_1)-st driving shaft, wherein a (c2_2)-nd driving shaft interlocked with the c2-nd driving motor and a (c2_2)-nd output shaft interlocked with the (c2_2)-nd driving shaft are sealingly installed on a (c2_1)-st opposite-end area of the (2_1)-st transfer link arm, wherein a (c2_2)-nd hollow hole is formed through the (c2_2)-nd driving shaft, wherein the (c2_1)-st output shaft of the (2_1)-st transfer link arm is fixedly coupled with a c2-nd linking member that is inserted into the c2-nd upper space of the transfer arm platform to be fixedly coupled with the c2-nd stopping member, wherein a (c2_2)-nd one-end area of the (2_2)-nd transfer link arm is fixedly coupled with the (c2-2)-nd output shaft of the (2_1)-st transfer link arm through a second fixed coupling shaft, wherein a c2-nd center area of the second common link arm is rotatably coupled with the second fixed coupling shaft, wherein a (c2_4)-th one-end area of the (2_1)-st subordinate link arm is rotatably coupled with the (2_1)-st blade of the transfer arm platform and a (c2_4)-th opposite-end area of the (2_1)-st subordinate link arm is rotatably coupled with a (c2_3)-rd one-end area of the second common link arm, wherein a (c2_5)-th one-end area of the (2_2)-nd subordinate link arm is rotatably coupled with the (2_2)-nd blade of the transform arm platform and a (c2_5)-th opposite-end area of the (2_2)-nd subordinate link arm is rotatably coupled with a (c2_3)-rd opposite-end area of the second common link arm, wherein (c2_6)-th one-end area of the (2_3)-rd subordinate link arm is rotatably coupled with a (c2_3)-rd opposite-end area of the second common link arm, wherein a (c2_7)-th one-end area of the (2_4)-th subordinate link arm is rotatably coupled with a (c2_6)-th opposite-end area of the (2_3)-rd subordinate link arm and a (c2_7)-th opposite-end area of the (2_4)-th subordinate link arm is rotatably coupled with the (c2_2)-nd opposite-end area of the (2_2)-nd transfer link arm, and wherein the second end-effector is fixed to the (c2_7)-th opposite-end area of the (2_4)-th subordinate link arm to thereby support the substrate.

2. The method of claim 1, wherein the travel robot rotates in conjunction with a rotational movement of the elevating shaft according to an operation of the elevation driving unit of the elevating robot, to thereby determine a travel direction of the travel robot,
wherein the transfer robot travels linearly in the travel direction according to an operation of the b1-st driving motor of the travel robot, to thereby determine a transfer position of the transfer robot for transferring the substrate, and
wherein the transfer robot rotates according to an operation of the b2-nd driving motor of the travel robot, to thereby determine a transfer direction of the transfer robot for transferring the substrate.

3. The method of claim 2, wherein the b1-st driving motor and the b2-nd driving motor of the travel robot operate sequentially to determine the transfer position and the transfer direction of the transfer robot, or operate simultaneously to determine the transfer position and the transfer direction of the transfer robot.

4. The method of claim 2, wherein the elevation driving unit of the elevating robot and the b2-nd driving motor of the travel robot operate sequentially to determine the travel direction of the travel robot and the transfer direction of the transfer robot, or operate simultaneously to determine the travel direction of the travel robot and the transfer direction of the transfer robot.

5. The method of claim 1, wherein a height of the second fixed coupling shaft is set as higher than a height of the first fixed coupling shaft such that the first end-effector and the second end-effector are positioned at different heights on a same route.

6. The method of claim 1, wherein the transfer arm platform of the transfer robot further includes a c1-st wiring hole connecting the c0-th upper space and the c1-st lower space; and a c2-nd wiring hole connecting the c0-th upper space and the c2-nd lower space.

7. The method of claim 1, wherein the transfer arm platform of the transfer robot includes an upper plate and a lower plate, wherein the upper plate includes the (1_1)-st blade, the (1_2)-nd blade, the (2_1)-st blade and the (2_2)-nd blade, and wherein the lower plate is coupled with the upper plate,
wherein a c0-th upper coupling hole, which is a part of the c0-th coupling hole, is formed at the c-th central area of the upper plate, wherein a c1-st upper coupling hole, which is a part of the c1-st coupling hole, is formed at the c-th one-end area of the upper plate, and the c1-st stopping member, through which the c1-st vertical through-hole is formed inside the c1-st upper coupling hole, compartmentalize an inner space of the c1-st upper coupling hole, wherein a c2-nd upper coupling hole, which is a part of the c2-nd coupling hole, is formed at the c–th opposite-end area of the upper plate, and a c2-nd stopping member, through which the c2-nd vertical through-hole is formed inside the c2-nd upper coupling hole, compartmentalize an inner space of the c2-nd upper coupling hole,
wherein a c0-th lower coupling hole, which is another part of the c0-th coupling hole, is formed at the c-th central area of the lower plate, and the c0-th stopping member, through which the c0-th vertical through-hole is formed inside the c0-th lower coupling hole, compartmentalize an inner space of the c0-th lower coupling hole, wherein a c1-st lower coupling hole, which is another part of the c1-st coupling hole, is formed at the c-th one-end area of the lower plate, wherein a c2-nd lower coupling hole, which is another part of the c2-nd coupling hole, is formed at the c-th opposite-end area of the lower plate.

8. The method of claim 7, wherein a c1-st upper wiring slot and a c2-nd upper wiring slot are formed at a lower surface of the upper plate, wherein the c1-st upper wiring slot connects an inner space of the c0-th upper coupling hole with a lower space of the c1-st upper coupling hole, and wherein the c2-nd upper wiring slot connects the inner space of the c0-th upper coupling hole with a lower space of the c2-nd upper coupling hole, and
wherein a c1-st lower wiring slot and a c2-nd lower wiring slot are formed at an upper surface of the lower plate, wherein the c1-st lower wiring slot connects an upper space of the c0-th lower coupling hole with an inner space of the c1-st lower coupling hole, and wherein the c2-nd lower wiring slot connects the upper space of the c0-th lower coupling hole with an inner space of the c2-nd lower coupling hole.
